(19) United States
(12) Patent Application Publication
(10) Pub. No.: US 2026/0054864 A1
(43) Pub. Date: Feb. 26, 2026

(54) DEVICE AND METHOD FOR FLIGHT MODE TRANSITIONING IN A VTOL AIRCRAFT

(71) Applicant: COLUGO SYSTEMS LTD, Yavne (IL)

(72) Inventor: Amit REGEV, Yavne (IL)

(21) Appl. No.: 19/104,226

(22) PCT Filed: Aug. 17, 2023
(86) PCT No.: PCT/IL2023/050878

§ 371 Date: Feb. 16, 2025

(30) Foreign Application Priority Data
Aug. 17, 2022 (IL) 295732

(51) Int. Cl. B64U 40/10; B64U 10/20

(52) U.S. Cl. CPC B64U 40/10; B64U 10/20

(57) ABSTRACT

A flight mode transitioning device, method and system configured to facilitate transitioning between vertical flight mode and horizontal flight mode in a vertical take-off and landing (VTOL) aircraft, the device comprising at least one actuator mediated member capable of limiting the movement the aircraft wing so as to enable both forward fight and vertical flight.

### FIELD OF THE INVENTION

The present invention relates to a device and a method for facilitating flight mode control of muti-rotor aircrafts and in particular, to such a device and method that facilitate quick and safe switching between vertical and horizontal flight modes.

### BACKGROUND OF THE INVENTION

Unmanned aircrafts have become important in today's society. Their importance and value has grown dramatically in recent years, leading to widespread adoption in commercial, military and consumer market sectors. Part of the reason for their popularity is their low cost and small form factor as compared to piloted aircraft.

Hybrid aircrafts use a combination of Vertical Takeoff and Landing (herein “VTOL”) propulsion systems to allow the aircraft to take-off, land and hover vertically (e.g., like a helicopter) while also allowing for forward propulsion systems as is common for fixed-wing forward flight aircrafts (e.g., like an airplane).

A hybrid quadrotor aircraft, for example, uses four vertical rotors for VTOL functions and one or more horizontal or forward propulsion rotors for forward flight. Such hybrid aircrafts allow for controllable flight dynamics by individually controlling the motor power profile, for example RPM, of each rotor to control the maneuverability of the aircraft.

Hybrid aircrafts attempt to combine both vertical and forward flight modes, however, such combined flight optimization of both flight modes has been elusive, as the requirement for stabilization of each flight mode is distinct.

Forward flight mode is typically stable for fixed wing aircrafts. However, such fixed winged aircrafts present a challenge and destabilizing factor during vertical (VTOL) flight mode, particularly in windy conditions.

Similarly, pure VTOL multirotor aircraft designs are generally wingless and while adept at vertical maneuvering, however, they are less efficient for forward flight.

### SUMMARY OF THE INVENTION

There is an unmet need for, and it would be highly useful to have, a device and method for quick and safe transitioning between vertical and horizontal flight modes in a VTOL enabled aircraft.

Generally, aircrafts such as airplanes, helicopters, drones, are controlled in a different manner to achieve the same type of flight maneuver. For example, forward flight in a helicopter and an airplane are achieved by controlling and/or manipulating different flying surfaces and engines and/or rotors. Accordingly, each aircraft type controls its flying surfaces and engines and/or motors that are available to it to achieve the type of flight and/or maneuver that is required. Sometimes a maneuvers in one aircraft is contra verse to a maneuver required in a second aircraft to achieve the same flight maneuver.

For example, the flight controls manipulations required to achieve climbing and speeding up, with a fixed winged airplane is contra verse to the flight control maneuvers required in a multirotor aircraft. In a multirotor aircraft, the required maneuvers include tilting forward, in a negative pitch, and increasing vertical motor power. Conversely, to achieve the same flight maneuver in a fixed wing airplane, the exact opposite configuration is required. Namely, the fixed wing airplane requires pitching up in a positive pitch and increasing the power to the horizontal motor. Accordingly, control in a mixed aircraft that effectively fuses both type of aircrafts, having both vertical motors, as with a multirotor, and horizontal motors, as with a fixed wing airplane, is difficult to achieve as the aircraft behaves differently under different conditions and aircraft configurations. Such mixed aircrafts maximize and combine the horizontal flight efficiency available with fixed winged aircrafts and vertical flight efficiency (VTOL) available with multirotor aircrafts. However, such a combination renders it a challenge to adequately control the mixed aircraft under different configurations.

Embodiments of the present invention provide a device, system and method for controlling the flight maneuver of such a mixed aircraft. Embodiments of the present invention achieve such control by providing an aircraft that features wings that may be both fixed, during horizontal flight, and loose and/or not-fixed, capable of freely rotating about their axis, during vertical flight (VTOL) while providing full and efficient control of the aircraft.

In order to produce controllable lift forces, an aircraft's wings must have flow of air directly from the front (leading edge) of the wing and in a very limited angle range. In VTOL aircrafts when the objective is to be in a stable position above the ground, for example when hovering, most of the time the wind is not from a desired or controllable direction, and therefore wind introduces a destabilizing factor that may leads to instability. Therefore, if a flow of air, for example due to wind, comes out of the range or from different directions not only does such wind not generate lift in fact it has a negative effect in that it creates a sail side effect. Such sail effect leads to the instability of the aircraft and could lead to the overall loss of control of the aircraft, in terms of the aircraft drifting or involuntarily moving to an uncontrolled or unwanted location, or at worst it could lead to such instability that the aircraft may crash altogether. This wind born lack of control and/or lack of stability is particularly evident during VTOL maneuvering and/or hovering.

In order to land safely sometimes the lift forces acting on the aircraft must be eliminated, and therefore fine control of lift forces is paramount in VTOL enabled aircrafts. This is an important control factor as a primary contributing factor of the control over the aircraft is established by gravitational forces acting on the aircraft. Since lift forces counteract and/or eliminate the gravitational forces acting on the aircraft, accordingly, control of the lift forces is paramount for adequately controlling the aircraft particularly during VTOL maneuvering. Without fine control of the lift forces acting on the aircraft can lead to overall loss of control of the aircraft.

Conversely to vertical flight maneuvering (VTOL), while flying forward and/or horizontally flight, the aerodynamics of flow over the wings is completely different where the air over the wings provides full control over the aircraft and therefore utilizes the wings in a very efficient manner. Accordingly, for horizontal flight a fixed wing is advantageous as it provides stability for such forward flight.

This is why loose and/or non-fixed wings are vital for the VTOL stage, vertical flight, while locked and/or fixed wings are important and/or advantageous during forward and/or horizontal flight. The controlled transition between these stages is a challenge solved by embodiments of the present invention.

Accordingly, there is an unmet need for, and it would be highly useful to have, a device, apparatus and method for quick and safe transitioning between vertical and horizontal flight in a VTOL enabled aircraft. In order to solve this problem, the challenge of the solution embodiment of the present invention provide a device, apparatus and method that controllably lock and unlock the flight surfaces, for example including but not limited to wings and/or rudders, according to the type of flight that is required namely VTOL, hovering, horizontal or forward.

Embodiments of the present invention provide a locking and unlocking device, apparatus and method configured such that it controls the position of the wing during the locking process by way of controlling the initial wing location and controlling the wing position such that it rotates to the correct position just prior to locking the wing allowing the wing to be locked into position.

One form of wing locking solutions taught in U.S. Pat. No. 5,280,863 to Schmitte utilized with a substantially fixed wing aircraft that allows for limited angulation of the wing. This wing locking solution requires heavy and powerful mechanisms to overcome the huge forces that are generated during flight and in particular forces that the wind creates on the wings' surfaces. This significantly adds weight to the aircraft and therefore introduces a control challenge. In such solutions, the locking device controls the wing directly to control the wing's position relative to the aircrafts body. Therefore it cannot be used with a fully vertical flying aircraft, as it cannot fully control the wing's position about its axis. Accordingly, such wing positional control may render the aircraft unstable particularly in windy conditions, as it does not account for the aerodynamic flow about the wing. Furthermore, the added weight of the locking mechanism renders the aircraft heavier and therefore less efficient.

Accordingly, a locking device that is operationally simple, weighs less while exploiting wing aerodynamically to properly time and position the wings would be advantageous, as is provided in the present invention.

Embodiments of the present invention utilizes all the aircraft control means, sensors and the aerodynamic forces to bring the wings sufficiently close to the correct positional alignment with the aircraft body by control the aircraft flight direction and the wing's control surfaces; once the wings are properly aligned all that is left is to do is lock the wing relative to the aircraft body with a relatively small, low powered and reliable actuator. Moreover, such a method and solution, according to embodiments of the present invention, also produces a natural and fluent transition, and therefore aerodynamically sound transition, which is make the transition safe and fast.

The present invention overcomes these deficiencies of the background by providing a device and method for flight mode transitioning wherein a VTOL loose wing is locked into position to become a fixed wing allowing for safe and efficient forward and/or horizontal flight. Similarly, the VTOL wing is configured to be a loose wing which allows the aircraft to be stable while hovering or in the landing and takeoff since such loose wing is optimal for hovering and vertical (VTOL) flight conditions. Accordingly, the device and method according to embodiments of the present invention provide for optimizing VTOL aircrafts by providing an efficient solution for both horizontal and vertical flight modes that may be transitioned therebetween both safely and readily.

Wind creates lift while air flow over the wings in a certain angle of attack, unlike fixed wing aircrafts VTOL which are fixed and controlled by a negative angle of the vertical motors versus the VTOL on the embodiment the wings can use the wings for lift even while hovering since the wings are free to move to an ideal angle when the wing's surfaces are moving up to equalize the torque to create an ideal lift and not interfere with the VTOL control in a way that the vertical motors reduce and safe power due to the help of the wind lift, this ability increase the hovering endurance while other multirotor and fixed wing VTOLs hovering endurance reduced.

Within the context of this application the term flying surfaces may refer to any one or more surface that controls and/or affects flight for example including but not limited to wing(s), rudder(s), stabilizer(s), the like or any combination thereof or the like.

While the present application is described by way of figures and examples with respect to a multi-rotor aircraft having tandem wing arrangement, however, the present invention is not limited to such multi-rotor aircrafts. As would be appreciated by a skilled artisan the present invention may be applied to any form and/or type of aircraft having VTOL capabilities, for example including but not limited to tailsitter, tiltrotor, tiltwing, quadcopter, tilt-quadcopter, airplane, flying wing, or the like.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1A-B are schematic block diagrams of exemplary VTOL enabled aircraft according to embodiments of the present invention; FIG. 1A shows a VTOL aircraft having vertical rotors; FIG. 1B shows a VTOL aircraft comprising both vertical and horizontal rotors;

FIG. 2 is a schematic flow chart of an exemplary method for transitioning between vertical flight mode to horizontal flight mode and vice versa according to embodiments of the present invention;

FIG. 3 is a schematic block diagram of an exemplary flight mode transition device according to embodiments of the present invention;

FIG. 4A-C are schematic illustrative diagrams of a multirotor aircraft according to embodiments of the present invention; FIG. 4A shows a perspective view a non-limiting aircraft showing operation during vertical flight mode (VTOL);

FIG. 4B is a perspective view of a non-limiting aircraft showing flight during transitioning stages between vertical flight and horizontal flight; FIG. 4C shows a perspective view of a non-limiting aircraft showing horizontal flight following a transition from vertical flight mode;

FIG. 5A-C are schematic illustrative diagrams of an exemplary wing according to embodiments of the present invention; FIG. 5A shows a perspective view of the wing in a horizontal flight configuration according to embodiments of the present invention; FIG. 5B shows a perspective view of the wing during vertical flight mode (VTOL) wherein the flaps are raised; FIG. 5C shows a perspective view of the wing during vertical flight mode (VTOL) wherein the flaps are lowered;

FIG. 5D is a close up view of a schematic illustrative diagrams of an exemplary wing recess according to embodiments of the present invention;

FIG. 6A-C are schematic illustrative diagrams of an exemplary flight transitioning device according to embodiments of the present invention; FIG. 6A is a perspective view the device during vertical flight (VTOL); FIG. 6B is a perspective view of the device during transitioning stages between vertical flight and horizontal flight; FIG. 6C is a perspective view of the transitioning device during horizontal flight following a transition from vertical flight mode; and

FIG. 7A-D are schematic illustrative diagrams showing a close up view of the interface of wing and flight transitioning device at different stages of flight transitioning from vertical flight to horizontal flight according to embodiments of the present invention; FIG. 7A is a perspective view the device during vertical flight (VTOL) just prior to initiation of a transition phase; FIG. 7B is a perspective view of the device during transitioning stages between vertical flight and horizontal flight;

FIG. 7C is a top down close up view of the transitioning device as it interfaces with the wing at the end of a transition from vertical flight mode; FIG. 7D is a top down close up view of the transitioning device as it interfaces with the wing at the end of a transition from vertical flight mode;

FIG. 8 is a schematic block diagram of an exemplary flight mode transition device according to embodiments of the present invention;

FIG. 9 is a schematic flow chart of an exemplary method for transitioning between vertical flight mode to horizontal flight mode and vice versa according to embodiments of the present invention;

FIG. 10A-E are schematic illustrative diagrams of an exemplary flight transitioning device according to embodiments of the present invention; FIG. 10A is a perspective view the device during forward horizontal flight; FIG. 10B is a top view of the device during forward horizontal flight mode; FIG. 10C is a perspective view of the transitioning device during vertical flight (VTOL); FIG. 10D is a perspective view of the transitioning device during vertical flight (VTOL); FIG. 10E is a perspective view of the transitioning device with the wings removed; and

FIG. 11A-B are schematic illustrative diagrams of an exemplary flight transitioning device rail assembly according to embodiments of the present invention; FIG. 11A is a perspective view the wing rail portion; FIG. 11B is a perspective view of the body rail portion;

FIG. 12 is a schematic block diagram of an exemplary flight mode transition device featuring a dual action configuration according to embodiments of the present invention;

FIG. 13 is a schematic illustrative diagram of an exemplary dual action flight mode transition device according to embodiments of the present invention;

FIG. 14A-B are different views of a schematic illustrative diagram of an exemplary dual action flight mode transition device according to embodiments of the present invention; FIG. 14A shows the device in the limiting configuration; FIG. 14B shows the device in the locking configuration;

FIG. 15A-D are different views of a schematic illustrative diagram of an exemplary dual action flight mode transition device according to embodiments of the present invention; FIG. 15A shows a perspective view of the assembly in an unlocked configuration; FIG. 15B shows a close up view of the assembly in a transitioning configuration; FIG. 15C shows a close up view of the assembly in a limiting configuration; FIG. 15D shows a close up view of the assembly in a locking configuration;

FIG. 16A-B are different views of a schematic illustrative diagram of an exemplary flight mode transitioning device according to embodiments of the present invention; FIG. 16A shows the device in the limiting configuration; FIG. 16B shows the assembly in the locking configuration;

FIG. 17 is a schematic flow chart of an exemplary method for transitioning between vertical flight mode to horizontal flight mode and vice versa according to embodiments of the present invention;

FIG. 18 is a schematic flow chart of an exemplary method for transitioning between vertical flight mode to horizontal flight mode and vice versa according to embodiments of the present invention; and

FIG. 19 is a schematic flow chart of an exemplary method for transitioning between vertical flight mode to horizontal flight mode and vice versa according to embodiments of the present invention;

### DESCRIPTION OF THE PREFERRED EMBODIMENTS

The principles and operation of the present invention may be better understood with reference to the drawings and the accompanying description.

The following figure reference labels are used throughout the description to refer to similarly functioning components are used throughout the specification hereinbelow.
100 multirotor aircraft;
101 aircraft body;
101h horizontal body portion coupling horizontal rotor;
101v vertical body portion coupling vertical rotors;
101w wing body portion coupling wings;
102 wing;
102a axial channel;
102b wing lock recess;
102c wing lock recess gate/cover;
102d wing lock position;
102e wing extension member;
102f wing flaps;
102L leading edge;
102t trailing edge;
104 stabilizer;
104a axis;
104r rudder control surface;
105 flight transitioning device;
105a actuator(s);
105b actuator adaptor;
105c manipulation cable;
105d locking member/pin housing;
105e locking member/pin;
105i electronics interface;
105s support member;
106 vertical rotor assembly;
107 lock member assembly;
107a cross arm;
107b body portion rail;
107c rail assembly;
107w wing portion rail;
107f rail fixed end;
107o rail open end;
107s body rail shaft end;
107r rail/track
108 horizontal rotor assembly;
110 electronic circuitry module;
112 power module;
116 communication module;
115 flight computer;
118 positioning sensor, GPS;
120 sensor module;
125 dual action transition assembly;
125a first action limiting member;
125b second action locking member;
130 electromagnetic lock assembly;
132 first housing;
134 second housing;
136 electromagnetic locking member;

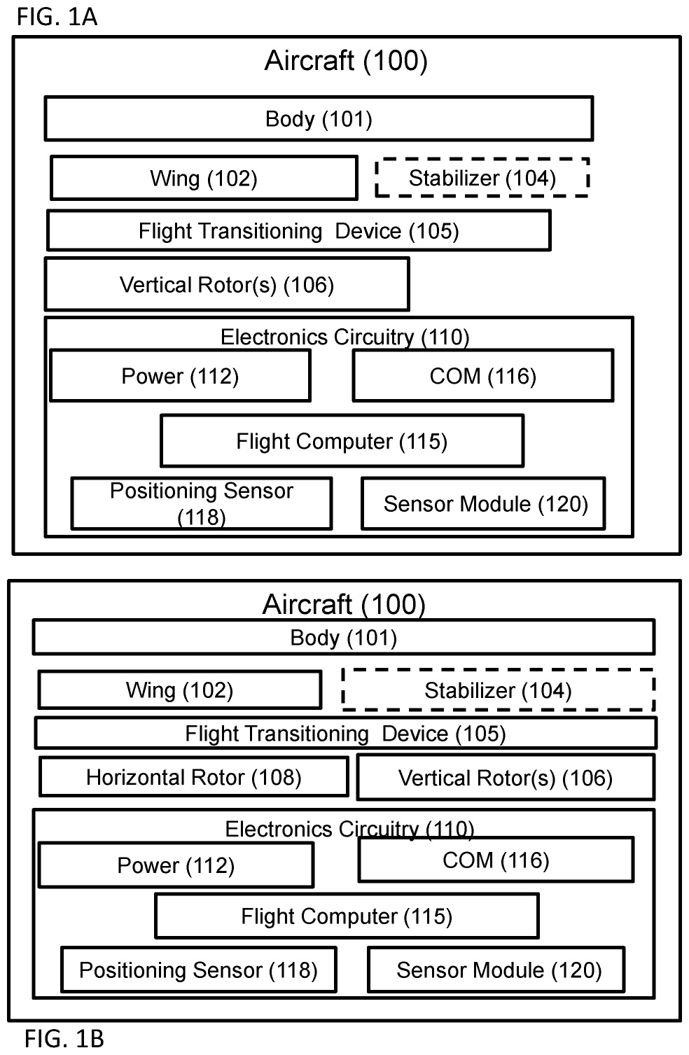

FIG. 1A-B show schematic block diagrams of optional VTOL aircrafts 100 featuring a flight mode transition device 105 according to embodiments of the present invention, that is preferably configured to provide both a wing limiting device and a wing locking and releasing device.

FIG. 1A shows a VTOL aircraft 100 having at least two or more vertical rotors 106, and FIG. 1B shows a VTOL aircraft 100 that further comprises at least one vertical rotor 108, according to embodiments of the present invention.

Multirotor and/or VTOL aircraft 100 is configured for optimizing both vertical flight and horizontal and/or forward flight and allows for a safe and aerodynamically efficient transition between the different flight modes by utilizing device 105. In embodiments device 105 is configured to provide for such flight mode transitioning by first limiting the range of motion of the aircraft wing or the like lift generating surface and secondly by locking and unlocking the aircraft wing 102 with respect to the aircraft body 101, as will be described and shown in greater detail below.

In some embodiments, device 105 may be provided in a split and/or dual action configuration 125 featuring a limiting member 125a and a locking member 125b, as discussed in greater detail in FIG. 12-15D.

In embodiments, device 105 is configured for locking at least one wing 102 to the aircraft's body 101 during forward flight, therein facilitating efficient horizontal forward flight. Device 105 is further configured to un-lock and/or release at least one wing 102 during vertical flight mode for example during vertical take-off, landing and hovering phases (VTOL), therein allowing at least one or more of the aircraft's wing 102 to freely rotate about an axis thereof so as to optimize vertical flight and maneuvering, such as hovering.

In embodiments, for example as shown in FIG. 1A, VTOL aircraft 100 comprises a body 101, at least one flight transitioning device 105, an electronics module 110, at least two or more vertical rotors 106, at least one or more wing 102. Optionally, VTOL aircraft 100 may further comprise at least one stabilizer 104, as shown in dashed lines. Optionally, such stabilizer may be a vertical stabilizer and/or a horizontal stabilizer.

In embodiments, for example as shown in FIG. 1B, VTOL aircraft 100 comprises a body 101, at least one flight transitioning device 105, an electronics module 110, at least two vertical rotors 106, at least one horizontal rotor 108, at least one wing 102, and at least one stabilizer 104, optionally a vertical stabilizer and/or a vertical stabilizer.

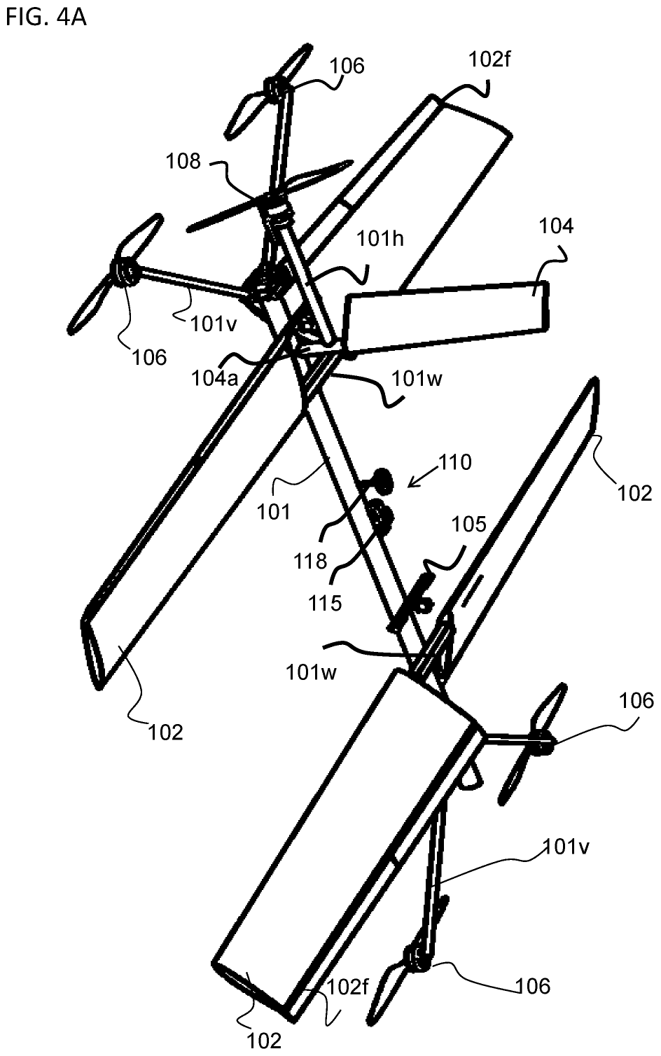

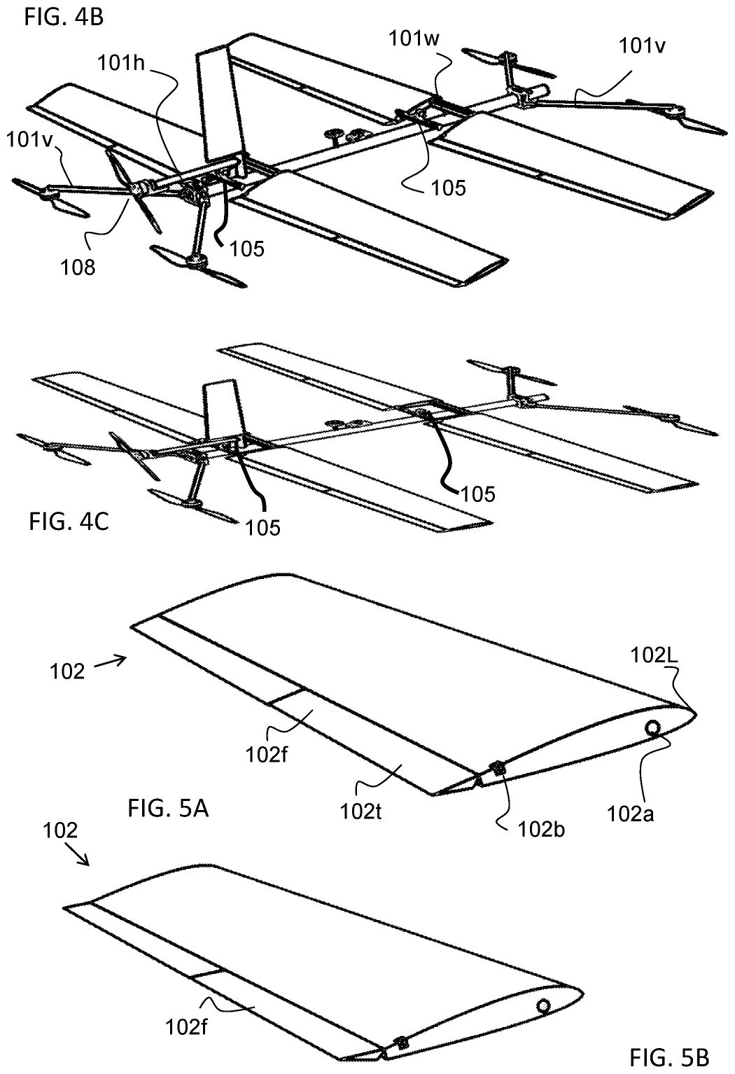

In embodiments, body 101 provides a fuselage of aircraft 100 forming the primary body of the multirotor aircraft provided for integrating the functional portions thereof. In embodiments body 101 may be provided from multiple integrated portions a non-limiting example of which is depicted in FIG. 4A.

In some embodiments, body 101 may comprise a body portion 101v provided for coupling at least one vertical rotor 106. Optionally, body 101 may comprise an equal number of body portions 101v and vertical rotors 106.

In embodiments, vertical rotor(s) 106 may be functionally coupled to a portion of body 101v with a controllable joint connection member (not shown) allowing for the controllable positioning of vertical rotor(s) 106 relative to body 101 in any three dimensional orientation. In embodiments, a portion of body 101 may be functionally coupled to a portion of body 101v with a controllable joint connection member (not shown) that provides for enabling the controllable positioning of body portion 101v relative to body 101 in any three dimensional orientation.

In some embodiments, body 101 may comprise a body portion 101h provided for coupling at least one horizontal rotor 108. Optionally, body portion 101h may further provide for coupling a vertical stabilizer to body 101, for example a shown in FIG. 4A.

In embodiments, body 101 may comprise an equal number of body portions 101h and horizontal rotors 108.

In embodiments, horizontal rotor 108 may be functionally coupled to a portion of body 101h with a controllable joint connection member (not shown) allowing for the controllable positioning of horizontal rotor(s) 108 relative to body 101 about its axis.

In embodiments, a portion of body 101 may be functionally coupled to a portion of body 101h with a controllable joint connection member (not shown) that provides for enabling the controllable positioning of horizontal body portion 101h relative to body 101.

In embodiments, body 101 preferably comprises a wing coupling portion 101w provided for functionally coupling at least two wings 102 to body 101. Preferably wing coupling portion 101w forms an axis along the length of wings 102 that allows wings 102 to rotate freely in the pitch axis relative to body 101. In embodiments wings 102 are airfoils that are configured to be responsive to airflow provided by non-controllable environmental factors such as the wind, so as to enhance positional control of the aircraft 100 during hovering and vertical maneuvering (VTOL).

In embodiments wing body portion 101w optionally comprises at least one or more selected from but not limited to an axial coupler, a slip ring or the like coupling member that is configured to provide for axial rotation of the wing along the full range (360 degrees) of the pitch axis.

In embodiments aircraft 100 comprises an electronic circuitry module 110 comprising the necessary electronics and circuitry to render aircraft 100 functional and operational.

In embodiments electronics module 110 may comprise a plurality of optional sub-modules for example including but not limited to a power supply module 112, a communication module 116, flight computer 115, and positional sensor module 118. Electronics module 110 may further comprise a sensor module 120.

In embodiments flight computer 115 provides the necessary processing hardware and/or software necessary to render multirotor aircraft 100 functional. In embodiments flight computer and/or processor 115 may provide for controlling any portion of aircraft 100 and in particular at least one or more selected from rotors 106,108, wings 102, stabilizer 104, flight transitioning device 105, or any combination thereof. For example, flight computer 115 may be utilized to determine the status of the at least one or more rotors 106,108 based on environmental conditions or the like sensed event in the vicinity of aircraft 100, for example the sensed event may for example include but is not limited to sensing changes in positioning provided from positioning sensor module 118 and/or additional sensors for example including but not limited to barometric pressure, altitude sensor that may be optionally provided with sensor module 120.

In embodiments power module 112 provides the necessary hardware and/or software to power aircraft 100 and in particular at least one or more rotors 106,108, device 105, therein rendering aircraft 100 operational. In embodiments power module 112 may be utilized to power device 100 rendering device 100 operational. Power supply 112 may for example be provided in optional forms for example including but not is limited to at least one or more of battery, rechargeable induction battery, induction coil, capacitors, super capacitors, photovoltaic cells, the like power source or any combination thereof.

In embodiments communication module 116 provides the necessary hardware and/or software to facilitate communication for aircraft 100 to communicate with optional auxiliary devices (not shown). For example, an auxiliary device may for example include but is not limited to other aircrafts, remote controller, a smartphone, a mobile processing and communication device, imaging device, servers, computer, aviation control center, air traffic/route control center, flight control center, area control center, first respondent call center, the like or any combination thereof.

In some embodiments communications module 116 may be utilized to provide device 100 with communication capabilities. For example, communication sub-module 116 may provide for communication with auxiliary devices and or systems by utilizing various communication protocols for example including but not limited to wireless communication protocols, cellular communication, wired communication, near field communication, Bluetooth, optical communication, the like and/or any combination thereof.

In embodiments electronics circuitry comprise memory module (not shown) that provides the necessary hardware and/or software to facilitate operations of aircraft 100 within the confines of flight computer 115 so as to enable storing and/or retrieving stored data and/or the like as is known in the art.

In embodiments electronics module 110 may further comprise a sensor module 120 that provides the necessary hardware and/or software to facilitate operations of at least one or more sensor(s) associated with aircraft 100 and/or device 105 to enable sensing various events in and around aircraft 100. In embodiments sensor module 120 may comprise at least one or more sensor selected from the group consisting of: temperature sensor, electrical conductance sensor, pressure sensor, barometric pressure sensor, light sensor, the like or any combination thereof.

In embodiments, aircraft 100 comprises at least three vertical rotors 106, as depicted in FIG. 1A,and optionally further comprising at least one horizontal rotor 108, for example as shown in FIG. 1B. Within the context of this application the term rotor refers to a motor with associated propellers. In embodiments the vertical rotors 106 may be provided in the form of tilt rotors. In embodiments horizontal rotor 108 is preferably a fixed rotor.

In embodiments, flight transitioning device 105 is preferably provided for facilitating the transition between vertical flight mode to horizontal and/or forward flight mode. Device 105 preferably allows for optimizing vertical flight mode, for example during hovering, vertical take-off and landing (VTOL) by enabling wings 102 to preferably be free to react to environmental conditions, for example to be free to rotate, about the pitch axis formed with wing body portion 101w, as previously described. In embodiments device 105 simultaneously provides for optimizing horizontal flight mode wherein wings 102 are preferably locked into position relative to body 101 so as to allow for forward flight with a stable and/or controllable pitch, for example as shown in FIG. 4C.

FIG. 3 shows a schematic box diagram of a flight mode transition device 105 according to embodiments of the present invention. Aircraft 100 preferably comprises at least one flight transition device 105 configured to be associated with a pair of wings 102. Optionally, aircraft 100 may comprise two or more flight mode transition devices 105 whereon each device 105 is associated with a pair of wings 102.

In embodiments device 105 comprises an actuator 105a, an adaptor 105b, and at least two locking members/pins 105e each locking member/pin is configured to be associated/disassociated with an individual wing 102. In embodiments, device 105 may optionally further comprise, as depicted with broken lines, at least one or more members selected from a support member 105s, manipulation cable 105c, lock member/pin housing 105d, and electronic circuitry interface 105i.

In embodiments, actuator 105a is preferably provided in the form of a lightweight actuator and/or motor for example in the form of a servo or the like actuator. Optionally actuator 105a may be a rotating actuator such as a servo or the like controllable motor. Optionally actuator 105a may be provided in the form of a linear actuator.

In embodiments actuator 105a provides for manipulating a locking member 105e so as to allow for extracting and retracting of the locking member 105e. The locking pin and/or member 105e configured to associate with a dedicated portion of wing 102, as will be discussed in greater detail below.

In embodiments adaptor 105b provides for translating the motion of actuator 105a to linear motion so as to allow for the linear displacement, namely, extracting and retracting of locking pin/member 105e with respect to a wing locking recess 102b of wing 102.

In preferred embodiments actuator 105a may be provided in the form of a servo motor, that is associated with an adaptor 105b that is associated with the locking member/pin 105e. Preferably, adaptor 105b provides for translating and/or adapting the rotational motion of the servo 105a to linear motion, extracting and retracting of the locking member/pin 105e.

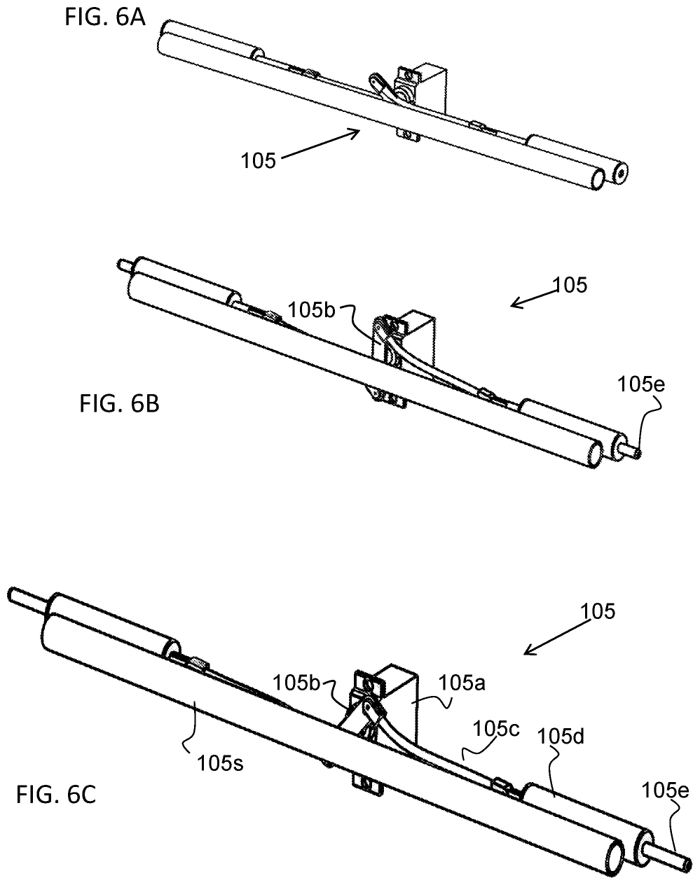

In some embodiments, adaptor 105b may be coupled with a manipulation cable 105c that interfaces on one end the adaptor 105b and on the opposite end the locking pin/member 105e, as best seen in FIG. 6A-C.

In some embodiments, lock pin/member 105e may be disposed within a lock pin housing 105d.

In embodiments device 105 may be provided with an electronic circuitry interface 105i preferably for functionally coupling device 105 with at least a portion of electronics circuitry module 110 and in particular flight computer 115, so as to enable the control and functionality of device 105 and actuator 105a.

In some embodiments device 105 may be provided with and/or integrated with the necessary electronics and circuitry, power supply, hardware and software, to render device 105 functional as an adjunct and/or independent unit.

In optional embodiments device 105 may be configured as an independent retrofit unit capable of being retrofit onto existing aircraft(s).

In embodiments, device 105 preferably comprises a support member 105s configured to provide structural integrity and support for device 105.

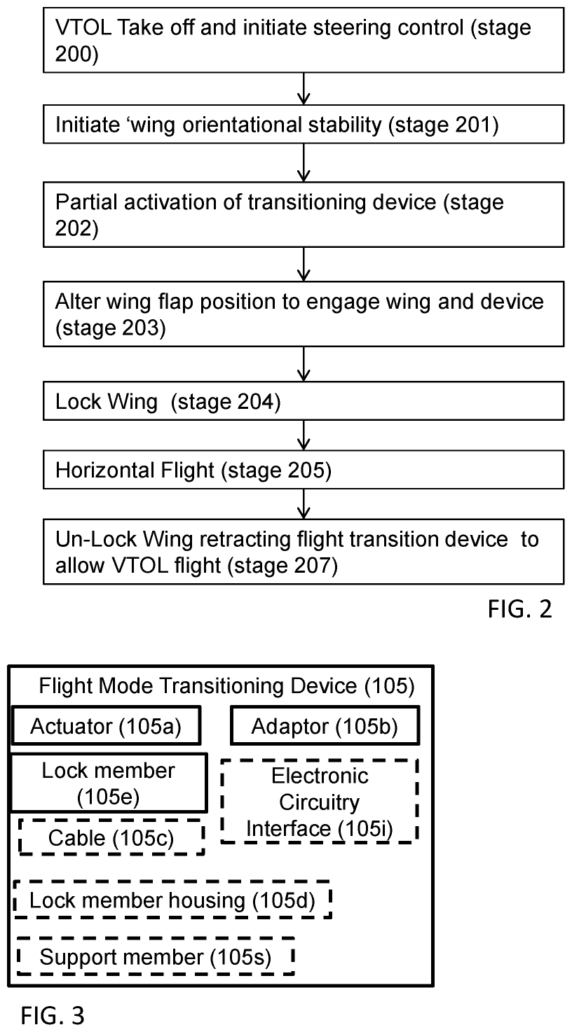

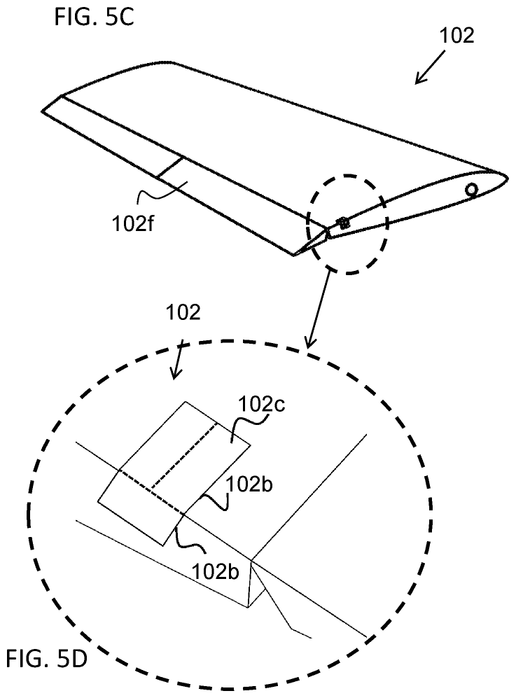

FIG. 2 showing a schematic flow chart depicting an exemplary method of use of device 105, a non limiting example of which is shown in FIG. 6A-C, with wing 102, for example as shown in FIG. 5A-C, each disposed on a VTOL enabled aircraft 100. In embodiments the method of use of wing locking device 105 enable for vertical flight to horizontal flight and vice versa, by exploiting the aerodynamic flow about wing 102 and by controlling wing flaps 102f, to allow for alignment between locking device 105 and wing 102. The method according to embodiments of the present invention provides for seamlessly and securely transitioning between vertical flight mode to horizontal flight mode and vice versa in an efficient manner.

In stage 200, a VTOL aircraft 100 is in a vertical flight mode and/or maneuver (VTOL) for example vertical take-off and/or hovering, for example as shown in FIG. 4A. At the end of the vertical flight mode wing 102 and device 105 are utilized to facilitate a seamless transition to horizontal flight mode. Flight computer 115 identifies the end of vertical flight stage and a need/requirement to transition to horizontal flight. Preferably throughout the transition period flight computer 115 provides for differentially controlling the various rotos of aircraft 100 so as to continuously control airflow about at least one or more wing 102 and/or flight control surfaces so as to properly position aircraft 100 relative to the required flight path.

Preferably flight computer 115 of aircraft 100 initiates flight transition maneuvering that may comprise controlled activation and/or deactivation and/or tilting of at least one or more rotors, for example including but not limited to horizontal rotor 108 and/or of at least one or more vertical rotor(s) 106 so as to prepare for horizontal flight.

Optionally flight transition may comprise other aerodynamic transitions and maneuvers for example to cause aircraft 100 to turn into the wind. Most preferably, the flight transition maneuvers are provided so as to facilitate locking wing 102 with device 105. Specifically provided to manipulate the rotors and/or wing flaps positioning 102f so as to cause wing 102 to align along their axis and in the direction of flight such that when engaged in forward flight the wing aligns parallel to body 101 so as to allow locking thereto with device 105, as described in more detail below.

Next in stage 201, flight computer 115 initiates flight transitioning mode by stabilizing wing 102. Wing 102 is aerodynamically stabilized by positioning wing flaps 102f upwardly, for example as shown in FIG. 4B and FIG. 5B. In embodiments, such wing stabilization maneuver may also allow for determining the spatial orientation of the wing relative to device 105.

Next in state 202, device 105 is initiated by activating actuator 105a to partially extend locking member 105e, for example provided in the form of a locking member/pin as schematically depicted in FIG. 6A-C. Preferably, locking member 105e is extracted in a sufficient manner so as to allow locking member 105e to engage and/or associate and/or interface with corresponding wing lock recess 102b, however, without locking. Such partial extension of locking member/pin 105e allows wing 102 and/or stabilizers 104 to rotate about their axis until such a time that wing lock recess 102b become engaged with the partially extended locking pin 105e, for example as shown in FIG. 4B. In embodiments, the wing 102 and stabilizer 104 respective axis is such that allow the respective surface to align with the direction of flight and therein when the aircraft flies forward it allows the wing 102 and/or stabilizer 104 to be locked with a device 105.

Next in stage 203, wing flaps 102f are positioned down, for example as shown in FIG. 5C, to allow wing 102 to rotate into position to engage device 105 about recess 102b.

Next in stage 204, following engagements between recess 102b and the partially extended locking member/pin 105e of device 105, actuator 105a is activated to fully extend locking member/pin 105e so as to lock wing 102.

Next in stage 205, horizontal flight is enabled in an optimized manner where wings 102 are locked to body 101 via device 105. Such horizontal flight is controllable as is known in the art and continues until a return to vertical flight maneuvering is required.

Next in stage 206 following horizontal flight and in a transition to vertical flight maneuvering, for example including hovering and/or VTOL, wings 102 are un-locked by disengaging locking member and/or pin 105e. Locking member/pin 105e of device 105 is retracted from recess 102b to release wings 102 allowing aircraft 100 to return to a vertical flight maneuvering optimization wherein wings 102 or stabilizers are capable to rotate freely about their axis as is necessary based on environmental conditions about wings 102 and body portion 101w.

Now referring to FIG. 4A-C showing schematic illustrative diagrams of a multirotor aircraft 100, similar to that depicted in FIG. 1B, in different stages during transition from vertical flight maneuvering to horizontal flight maneuvering.

FIG. 4A shows aircraft 100 wherein wings 102 are in the VTOL optimized configuration wherein wings 102 are free to rotate about their axis, as defined along the axis formed along wing body portion 101w that associates the wings 102 to body 101. As shown, aircraft 100 comprises two pairs of wings 102 each pair comprises an individual wing body portion 101w and a dedicated transitioning device 105. As shown, each of the wings 102 are free to rotate about their axis, along the axis formed by body portion 101w. As shown, preferably each wing comprises a flap 102f, shown in greater detail in FIG. 5A-C.

FIG. 4B shows the transitioning stage from vertical flight mode to horizontal flight mode wherein device 105 is utilized to lock wings 102 into position relative to body 101. As described in FIG. 2, during these transitional phases flight computer 115 can selectively manipulate the various rotors for example including but not limited to at least one or more of vertical rotor 108 and/or vertical rotors 106, while simultaneously controlling the wing flap 102f position so as to urge wings 102 into position relative to device 105. For example, increasing power on horizontal rotor 108 while reducing power on the front vertical rotors 106, and further directing wing flaps 102f in the up position, as shown, will urge wings 102 into the lockable position wherein wing lock recess 102b is in alignment with device 105 and the partially extracted locking member/pin 105e.

FIG. 4C shows the result of the transitioning phase where aircraft 100 is in horizontal flight where all four wings 102 are in the locked position with respect to body 101. Allowing for optimized forward and/or horizontal flight.

FIG. 5A-C show schematic illustrative diagrams of an exemplary wing 102 according to embodiments of the present invention. Wing 102 is provided in the form of an airfoil having a leading edge 102L, a trailing edge 102t, the trailing edge featuring flaps 102f that are responsive to airflow. Wing 102 further feature an axial channel that is disposed adjacent to the leading edge 102L and configured to associate with body 101 via wing body portion 101w, configured to allow wing 102 to rotate freely about their axis in response to air flow thereabout. Wing further comprising a wing lock recess 102b disposed adjacent to the trailing edge 102t, for example as shown. Most preferably flaps 102f are responsive to airflow and depict the vertical positioning of wing 102. Furthermore, flaps 102f provide for controlling the position of wing 102 relative to device 105 when transitioning from vertical flight mode to horizontal flight mode.

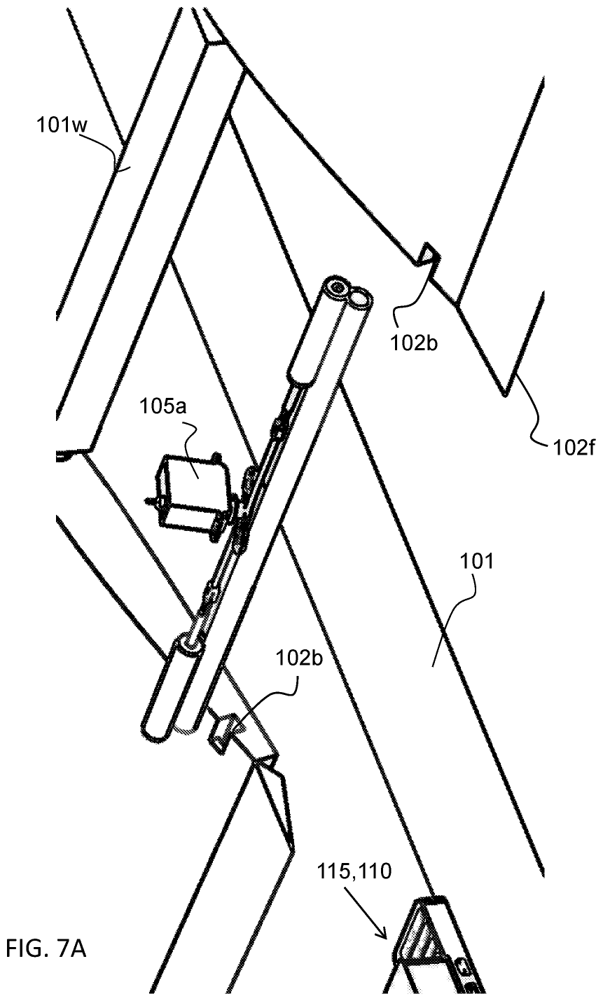

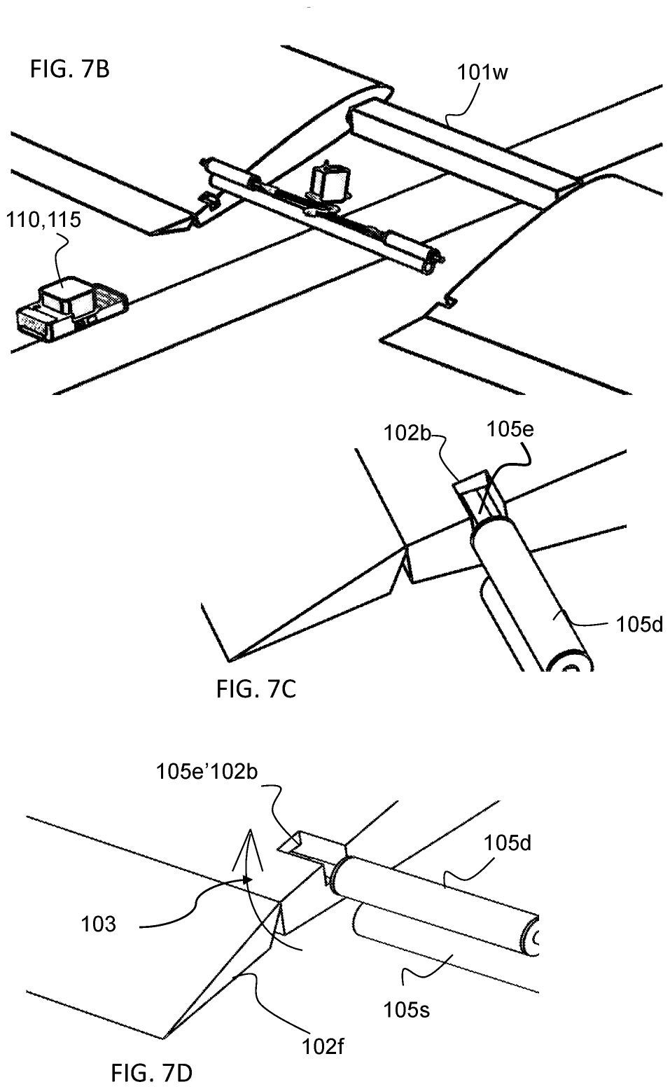

FIG. 5A shows a perspective view of wing 102 according to embodiments of the present invention wherein flaps 102f are not deflected up or down. FIG. 5B shows a perspective view of the wing during wherein the flaps 102f are raised, to bring about an elevation of wing 102, useful during the transition stages where to control the position of wing 102 relative to body 101 and particularly device 105. FIG. 5C shows a perspective view of the wing 102 wherein the flaps 102f are lowered, to bring about a lowering of wing 102. The positioning of wing flaps 102f is particularly important during the transitioning phases, to bring about alignment of wing lock recess 102b with device 105, as best shown in FIG. 7A-D.

Preferably such alignment and flap control 102f is provided by altering airflow about wing 102 by way of controlling the activity of at least one or more rotors 106,108 via flight control computer 115 as previously described.

FIG. 6A-C are schematic illustrative diagrams of an exemplary flight transitioning device 105 according to embodiments of the present invention. In embodiments, transitioning device 105 comprises an actuator 105a shown in the form of a servo motor, an actuator adaptor 105b provided for translating the rotational motion of the servo to linear motion, a manipulation cable 105c interfacing the adaptor 105b and a locking member 105e, shown in an optional non-limiting form of a locking pin, wherein the linear movement of locking pin 105e in an out of housing 105d is controlled with said actuator 105a. In embodiments, the degree of linear movement of locking pin 105e from housing 105d to extract, retract and/or detract the extension of pin 105e from housing 105d is controlled with flight computer 115. In some embodiments device 105 may be provided with an integrated circuitry and control module for intrinsic control and positioning of locking pin 105e.

In optional embodiments, transitioning device 105 may further comprise a support frame and/or member 105s for as shown in the form of a structural support member 105s.

In embodiments, locking member 105e may be provided in the form of locking pin member as shown, optionally locking member may also be configured as a clamp and/or grip and/or snap fit clam and/or friction fit clamp or the like mechanical catch member or device. In embodiments, clamp like locking member is preferably actuated with actuator 105a. In embodiments such locking member, for example in the form of a c-shaped grip or snap fit member (not shown), may be configured to engage with wing 102 about recess 102b after the initiation of a forward flight and once the aircraft reaches a particular horizontal speed at which time the “c-shaped” grip is closed by activation of actuator 105a to lock wing 102. In embodiments, the wing 102 and stabilizer 104 respective axis is such that allow the respective surface to align with the direction of flight and therein when the aircraft flies forward it allows the wing 102 and/or stabilizer 104 to be locked with a device 105. In embodiments such a c-shaped locking member may be utilized to further lock wing 102 at a particular and/or controllable angle of attack, such that the grip may be clamped to provide a selected attack angles. When unlocking clamp like locking member the lock is released so as to free wing 102 to optimize vertical flight maneuvering.

FIG. 5D shows a close up view of an optional embodiment of the wing recess 102b that may be fit with a gate and/or cover 102c along its upper side. The gate 102c may feature a two portion gate, a non limiting example of which is shown, that allows for controlled entry into recess 102b, for example in the form of swinging doors and two latches or the like. Optionally gate 102c may be provided in the form of a retractable door.

In embodiments gate 102c may be coupled to at least one or more sensor to control the open and/or closed state of gate 102c. For example, gate 102c may be associated with and/or rendered functional with a sensor for example including but not limited to hall effect sensor, optical sensor, infrared sensor, magnetic sensor, acoustic sensor, the like or any combination thereof.

FIG. 6A shows a perspective view device 105 during vertical flight mode (VTOL) and/or hovering wherein extraction pin 105e is fully retracted within housing 105d. Therein device 105 and wing 102 are not engaged. FIG. 6B shows a perspective view of device 105 during the transitioning stages between vertical flight and horizontal flight, wherein extraction pin 105 is partially extracted, for example up to 50% of the length of extraction pin 105e. This transitional configuration is provided such that extraction pin 105e can interface with the corresponding wing lock recess 102b prior to its locking.

FIG. 6C shows a perspective view of transitioning device 105 during horizontal flight wherein extraction pin 105e is fully extended from housing 105d. In such a configuration wing 102 is locked into position with body 101 to optimize forward flight. However, wherein transitioning back to vertical flight mode maneuvering require only to retract pin 105e so as to release wing 102 allowing it to once more rotate freely about the axis formed with body portion 101w.

FIG. 7A-D are schematic illustrative diagrams showing a close up view of the interface of wing 102 and flight transitioning device 105 at the different stages of flight transitioning from vertical flight to horizontal flight according to embodiments of the present invention. FIG. 7A shows a perspective view of the device during vertical flight maneuvering such as hovering and/or VTOL. As can be seen locking member 105e is fully retracted within housing 105d allowing releasing wing 102 to rotate freely about its axis.

FIG. 7B shows the transitioning phase of device 105, wherein locking pin 105e is partially extracted from housing 105d to allow for interfacing and/or catching pin 105e within recess 102b.

FIG. 7C-D show various close up views the final transitioning phases of device 105 as locking pin 105e is fully extracted within recess 102b so as to lock wing 102 for optimization horizontal flight. The movement of wing 102 is shown with curved directional arrow 103, FIG. 7D, as device 105 functions to lock wing 102 in a fixed position in preparation for horizontal flight.

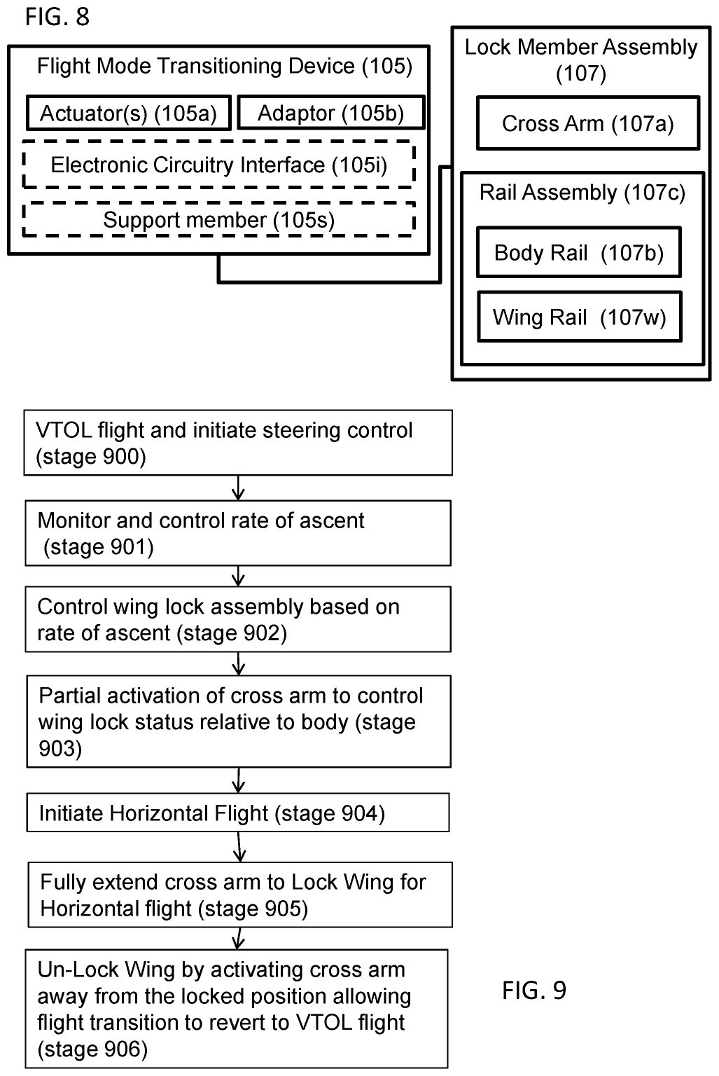

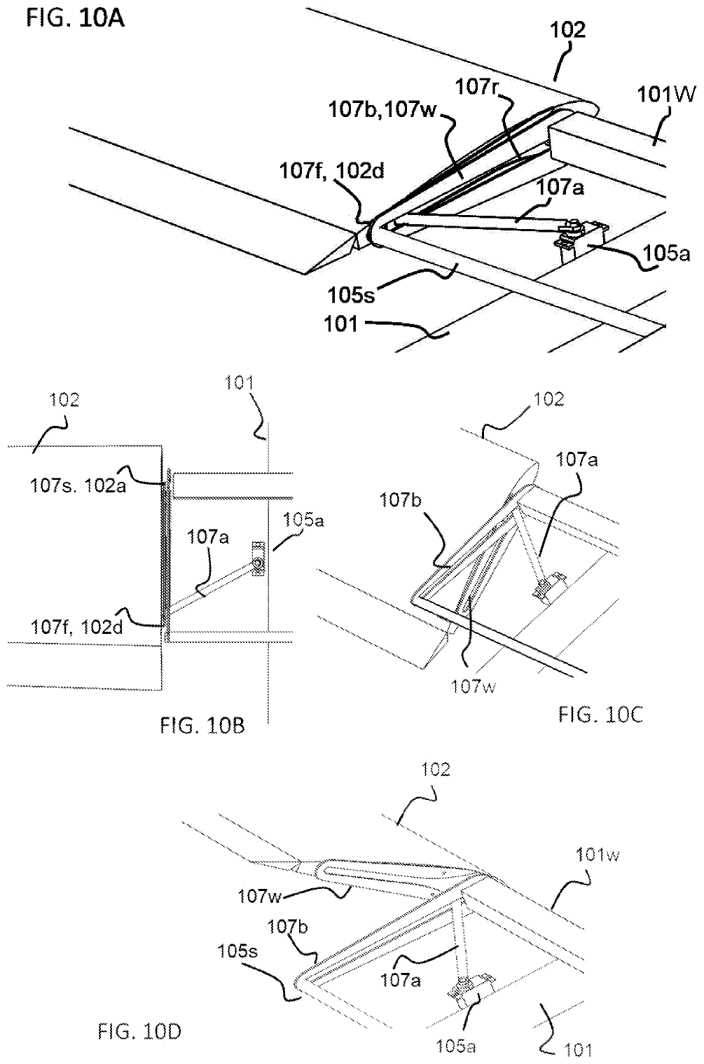

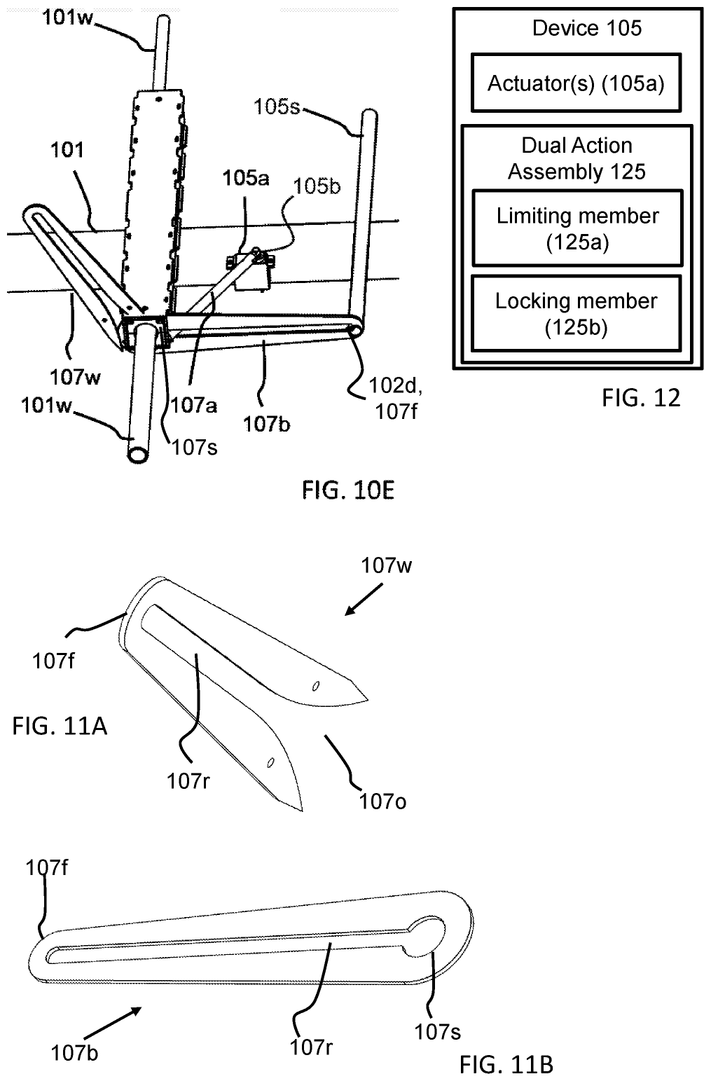

FIG. 8 shows a block diagram of an optional embodiment according to the present invention or a transitioning device 105 as previously described and depicted in at least FIG. 3 that further comprises a lock member assembly 107, a non limiting example of which is shown in FIG. 10A-E.

In embodiments lock member assembly 107 comprises a rail assembly 107c and a cross arm 107a. Preferably, cross arm 107a is configured to maneuver and/or travel along the length of rail assembly 107c. In embodiments cross arm 107a is associated with at least a portion of transitioning device 105 most preferably it is functionally associated with actuator 105a and optionally via an actuator adaptor 105b.

In embodiments, cross arm 107a provides for locking and unlocking a wing 102, associated with device 105 featuring locking member assembly 107. Preferably, cross arm 107a, and locking member assembly 107 are configured to assume an unlocked position along rail assembly 107c during vertical flight, VTOL, and/or hovering modes. Preferably, cross arm 107a, and locking member assembly 107 are configured to assume locked position along rail assembly 107c during horizontal and/or forward flight modes.

Optionally and preferably lock member assembly 107 is functionally associated with actuator 105a via adaptor 105b to facilitate translation of the actuator's movement to the movement of the lock member assembly 107, and in particular cross arm 107a.

In embodiments an individual actuator 105a may be individual to and/or specifically associated with an individual lock member assembly 107 and/or and individual flying surface, for example a specific wing or rudder or stabilizer, therein only used to service an individual lock member assembly 107 associated with a particular flying surface.

In some embodiments actuator 105a may be a shared actuator to service at least one or more lock member assemblies 107 and in particular at least one or more cross arms 107a. Accordingly, a single actuator 105a may be configured to control at least two or more cross arms 107a wherein each cross arm is associated with an individual flying surface, wing 102 and/or stabilizer 104.

In embodiments rail assembly 107c preferably comprises two rail sub-portions including a wing rail portion 107w configured to be associated with a portion of the wing 102 and a body rail portion 107b configured to be associated with a portion of the aircraft body 101, an non limiting example of which is depicted in FIG. 11A-B.

As discussed above lock member assembly 107 as part of device 105 preferably provides for facilitating the two way transition between VTOL flight mode to a horizontal flight mode and vice versa with device 105 so as to lock/unlock the wings 102 or the like flying surface, rudder 104, with respect to the aircraft body 101.

In embodiments assembly 107 allows for smoother and fine control of the transitioning phase between flight modes. Optionally and preferably by providing a support assembly that may be particularly useful for larger and/or heavier aircrafts and/or with wider wingspan.

In embodiments transitioning device 105 and support assembly 107 may be utilized on any wing or the like flying surfaces for example including but not limited to wings, rudders, stabilizers, any combination thereof or the like.

FIG. 9 shows a flowchart depicting the method of use of device 105 that features lock member assembly 107, a nonlimiting illustration of which is shown in FIG. 10A-E.

First in stage 900, vertical flight mode (hovering and/or VTOL) is initiated wherein the aircrafts 100 flight computer 115, vertical rotors 106, initiate flight and steering control. Most preferably during VTOL the flying surfaces and in particular wings 102 are in the unlocked and/or free position so as to allow them to freely rotate about their axis 102a.

Next in stage 901, flight computer 115 controls rate of ascent by controlling flight and in particular vertical motors 106.

Next in stage 902, flight computer 115 continuously monitors continuously rate of ascent, so as to determine when transition from vertical flight mode to horizontal flight mode is necessary.

Next in stage 903, in order to initiate transition from vertical flight to horizontal flight, wherein at least one or more flight surfaces, most preferably wings 102 are locked, transitioning device 105 activates motor 105a in order to activate lock member assembly 107 and in particular cross arm 107a. Cross arm 107a is initiated to initiate a maneuver from the first unlocked position along rail assembly 107c toward locked position along rail assembly 107c.

Next in stage 904, horizontal flight is initiated most preferably by initiating horizontal rotors 108. The horizontal flight further urges wings and/or other flying surfaces into a stabilized horizontal flight position.

Next in stage 905, actuator 105a is activated to fully extend cross arm 107a into the locked position of rail assembly 107c, therein locking the flying surface into position for horizontal flight. The locked position is maintained as necessary as determined by flight computer 115, util such a time as a transition back to vertical flight is necessary.

Next in stage, 906, once reverting back to vertical flight is determined, actuator 105a is activated to maneuver cross arm 107a from the locked position along rail assembly 107c toward an unlocked position along rail assembly 107c, therein allowing the flying surface and in particular wing 102 to be free to rotate about its axis 102a.

FIG. 10A-E show various views of the flight mode transitioning device 105 featuring support assembly 107, an example of which is depicted in FIG. 8. FIG. 10A shows a perspective view of a portion of an aircraft showing a portion of body 101, wing 102, that features device 105 and support assembly 107. As previously described, device 105 features a wing coupling portion 101w providing a wingspan axis configured to allow wings 102 to rotate freely, 360 degrees, about the axis 102a forms with coupling portion 101w.

Support assembly 107 features a cross arm member 107a that extends between aircraft body 101 and wing 102 along a rail assembly 107c. The position of cross arm member 107a is preferably controllable with an actuator 105a, for example in the form of a servo motor or the like. Preferably the cross arm 107a has a pivoting end associated with aircraft body 101 via actuator 105 and a rail end that shifts and/or moves along rail assembly 107c between open end 107s corresponding to the wings axial channel 102a a position wherein the wing 102 is allowed to rotate freely about the axis and a wing lock position 102d corresponding to fixed end 107f of rail assembly 107c, wherein the wing 102 is locked into position for horizontal flight. During horizontal flight mode, wing 102 is fixed in position, as previously descried, wherein cross arm 107a is positioned adjacent to wing lock position 102d. During vertical (VTOL, hovering) flight mode, the position of rail end of arm 107a moves toward axial channel 102a, position along rail assembly 107c.

Support assembly 107 preferably features a rail assembly 107c that provides a guide and/or rail for cross arm 107a as it pivotally travels between wing axial channel a102a and wing lock position 102d.

In embodiments rail assembly 107c comprises two rail sub-members a wing portion rail 107w, close up view shown in FIG. 11A, and a body portion rail member 107b, close up view shown in FIG. 11B. Rail assembly 107c is configured so as to both provide a track and/or rail 107r for support arm 107a to travel along, while further allowing wing 102 to rotate freely about its wingspan axis 101w, 102a or allowing wing 102 to be to be locked into a fixed position relative to aircraft body 101 at about locking position 102d. In embodiments, track 107r spans the distance between wing lock position 102d and wing axial channel 102a. Optionally and preferably the length of track 107r and/or the distance between position 102d and channel 102a is configurable based on wing parameters.

FIG. 10B shows a partial top down view of transitioning device 105 in use with support assembly 107 when wing 102 is about to be locked into position for horizontal flight. As shown, cross arm 107a is disposed adjacent to locking position 102d, and functions to support and approximate locking wing 102.

In embodiments, the positional control of support arm 107a is provided with an actuator 105a and may therefore allow for controlling the rate of locking wing 102 to body 101. Optionally and preferably the rate at which the support arm 107a is utilized may be configured relative to the rate of vertical flight so as to provide a smooth transition between flight modes, and most preferably controlled via flight computer 115.

FIG. 10C and FIG. 10D show a perspective view of support arm assembly 107 in use while wing 102 is free to rotate about its axis 102a relative to the aircraft body 101, wherein the wing 102 assumes different positions, above the plane of the support arm FIG. 10D, or below the plane of the support arm 107a, FIG. 10C.

FIG. 10E shows a close up perspective view of device 105 featuring actuator 105a and support member 105s and lock member assembly 107, wherein wing 102 and body 101 have been removed for illustrative purposes. Support member 105s is provided to allow for additional stability and support of the assembly.

As shown, cross arm 107a may be controlled with a dedicated actuator 105a, that may for example be provided in the form of a servo motor, or the like.

FIG. 10E further shows rail assembly 107c, that allows both for wing 102 to rotate freely about axis 101w,107s and to be locked with wing 102 at lock position 102d, 107f.

FIG. 11A shows wing side rail 107w having a fixed end 107f and an open end 107o. Preferably fixed end 107f is configured to align with locking position 102d while, open end 107o is configured to align with axial channel 102a. As previously shown, wing rail 107w is affixed to an end face of wing 102 adjacent to aircraft body 101 and disposed between channel 102a and locking position 102d. Most preferably a track and/or rail 107r is formed between fixed end 107f and open end 107o.

Most preferably open end 107o is configured as an open end so as to allow wing 102 to rotate freely about the wingspan axis 101w, 102a.

FIG. 11B shows body side rail member 107b featuring a fixed end 107f and a shaft end 107s. Preferably body side rail member 107b spans the distance between wingspan axis 101w and support member 105s. Preferably fixed end 107f is configured to align with locking position 102d while, shaft end 107s is configured to align with and associate with wingspan axis 101w, 102a, corresponding to the open end of wing 102. As previously shown, body rail 107b is affixed and/or associated to portion of the aircraft body 101 adjacent to wing 102 and aligned with wing side rail 107w, preferably between support member 105s and axis 101w.

In embodiment, rail member 107w and 107b are configured to align with one another such that the form a common track and/or trail 107r along which arm 107a may travel as controlled with actuator 105a.

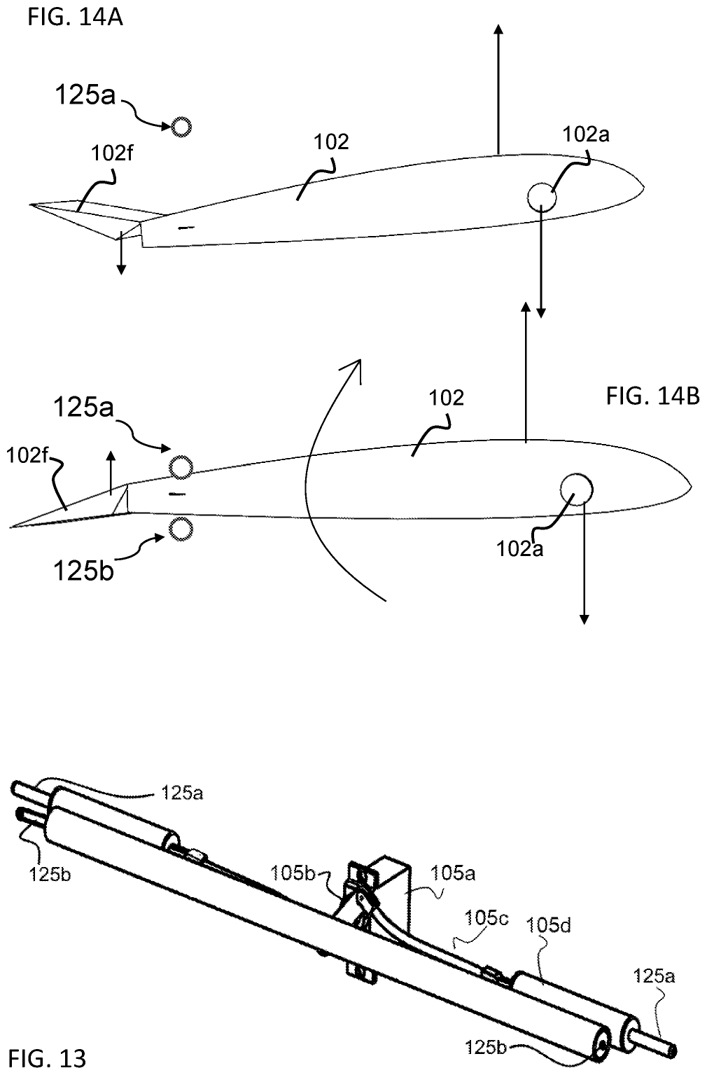

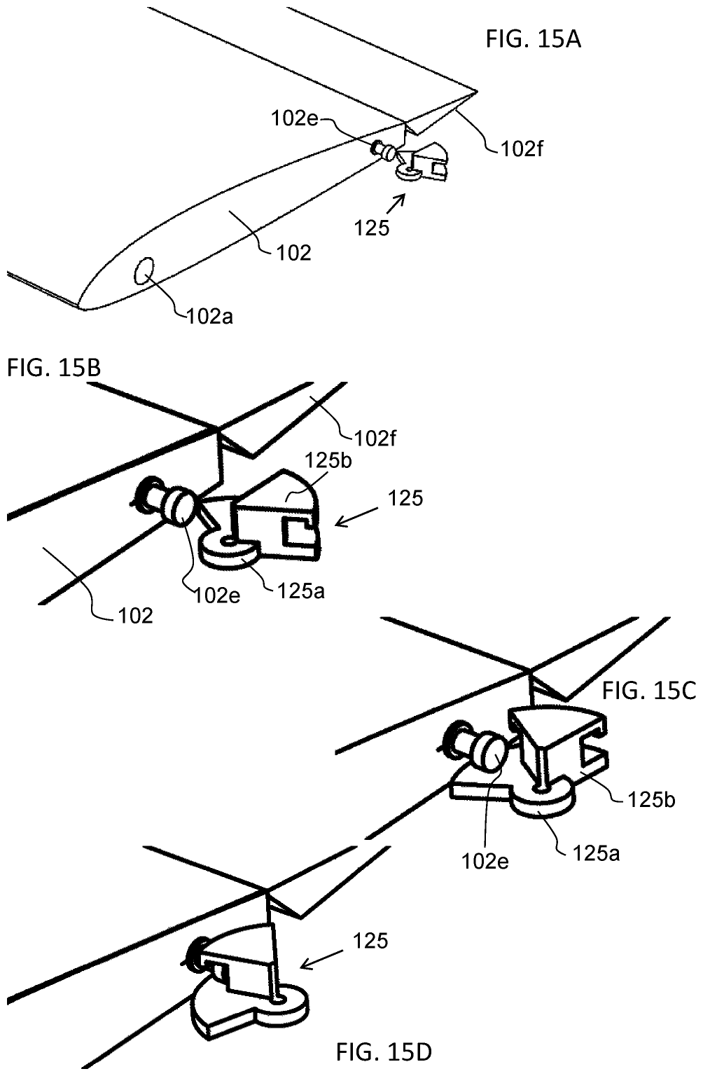

FIG. 12 shows an optional embodiment of device 105 featuring a dual action transition assembly 125 comprising at least two controllable members 125a,125b. A first action limiting member 125a may be provided in optional forms, for example including but not limited to” a linearly controllable member and/or pin-like member (FIG. 13, 14A-B), a rotationally controllable member (FIG. 15A-D), the like, or any combination thereof. A second action locking member 125b may be provided in optional forms, for example including but not limited to a linearly controllable pin member (FIG. 13, 14A-B), a rotationally controllable member (FIG. 15A-D), the like, or any combination thereof.

In some embodiments assembly 125 may be configured to have only a limiting member 125a and/or first action member 125a.

In embodiments, the dual action assembly 125 may be controlled by at least one or more actuator(s) 105a.

In an optional embodiment, each action member 125a, 125b may be individually controlled with a dedicated actuator 105a. In an optional embodiment a single actuator 105a may be utilized to differentially control both the first action limiting member 125a and the second action locking member 125b.

FIG. 13 shows an exemplary non limiting embodiment of transitioning device 105 featuring an optional dual action transitioning assembly 125, that is similar to the limiting device 105 depicted in FIG. 6A-C. FIG. 13 shows a non-limiting example of device 105, as previously described, however further featuring a dual action assembly 125, wherein the first action limiting member 125a is provided in the form of a controllable pin member that is linearly actuated with actuator 105a. Similarly, second action locking member 125b is provided is provided in the form of a controllable pin member that is linearly actuated with actuator 105a.

Optionally, transitioning assembly 125 may be provided solely with a limiting member 125a.

In embodiments first action limiting member 125a may be extracted and/or extended to limit a flying surface, for example including but not limited to a wing 102, rudder 104, stabilizer, or the like, with which device 105 is associated. As previously described a wing 102 is free to rotate about its axis 102a during vertical flight (VTOL) wherein both first and second action members 125a,125b are not extracted and/or detracted, therein allowing wing 102 or the like flying surface to rotate freely about its axis, for example wing axis 102a, particularly during vertical flight and/or hovering (VTOL). When transitioning to horizontal flight, the first action limiting member 125a provides for initiating the limitation of the flying surface from continuing to rotate freely about its axis. The second action locking member 125b provides for locking the flying surface into its position so as to allow for a more efficient horizontal flight.

As shown in FIG. 13 one side has both first and second action members 125a, 125b fully extracted therein the flying surface on that side is locked into position and can no longer rotate about its axis. The opposite side showing the transitioning phase where first action member 125a is extended to limit the flying surface's rotation about its axis while second action locking member 125b is not-extended, preferably in anticipation of the flying surface coming into its locking position so as to allow for securing and/or locking the respective flying surface by extracting the locking member 125b.

FIG. 13 shows dual action member in the non-limiting form of a linearly controllable pin member that can be extended or retracted by the action of at least one or more actuator 105a. Optionally actuator 105a may be associated with an adaptor to allow for linearly extracting or retracting the first and/or second action members 125a,125b, as similarly described with respect to FIG. 6A-C.

Now referring to FIG. 14A-B shows a side view of flying surface in the form of a wing 102 in use with a locking device featuring a dual action locking assembly 125, as described in FIG. 12-13. In order to lock wing 102 in preparation for horizontal flight with dual action assembly 125, initially the first action limiting member 125a, is extended, providing wing 102 with an upper limit and limiting its ability to rotate about its axis, as shown in FIG. 14A. As shown, wing flap 102f is positioned to so as to cause wing 102 to rotate up toward first action limiting member 125a.

As shown in FIG. 14B, when it is time to lock wing 102 for forward flight, at least one or more control surfaces 102f of wing 102, for example including but not limited to flaps 102f, are maneuvered so as to allow wing 102 to contract and/or interface with limiting member 125a, at which time locking pin member 125b is actuated and/or extended so as to lock wing 102 into position for horizontal flight. In embodiments, device 105 featuring dual action assembly 125 may be used with a wing 102 that does not feature a dedicated wing lock recess 102b as previously described.

When reverting to vertical flight mode dual action assembly 125 is retracted by retracting limiting member 125a and locking member 125b.

In some embodiments assembly 125 may be configured to feature only upper limiting member 125a, for example as shown in FIG. 14A, wherein upper limiting member 125a provides for limiting flying surfaces, for example wing 102 from upper rotation during forward flight while providing for efficient forward horizontal flight with the aircraft.

Now referring to FIG. 15A-D, shows an optional embodiment of a dual action assembly 125 in use with a device 105, wherein dual action assembly 125 is provided with a rotational actuation of the first and second action member 125a,125b.

FIG. 15A shows a perspective view of a flying surface 102 in use with a rotationally actuated dual action assembly 125 having a first action limiting member 125a and a second action locking member 125b. Wing 102 features an extension member 102e configured for interfacing with assembly 125, as best seen in FIG. 15C-D. Optionally extension member 102e is a fixed member extending from the wing edge, as shown. Optionally, extension member 102e is a non-fixed and/or retractable member that may be controllably extended from the wing edge, wherein during vertical flight extension member 102e may be flush with the wing edge surface, so as to allow wing 102 to rotate freely about its axis 102a.

FIG. 15B shows a close up view of extension member 102e initial interface with assembly 125. Optionally while preparing for vertical to horizontal flight transition first action member 125a is rotated toward extension member 102e so as to provide a rotational limiting for wing 102, as best seen in FIG. 15C. FIG. 15C shows interface between wing extension member 102e with first action limiting member 125a.

FIG. 15D shows a second action locking member 125b that is locked onto wing extension 102e so as to lock wing 102 into position for horizontal flight. As shown, second action locking member 125b is rotated most preferably with actuator 105a of device 105.

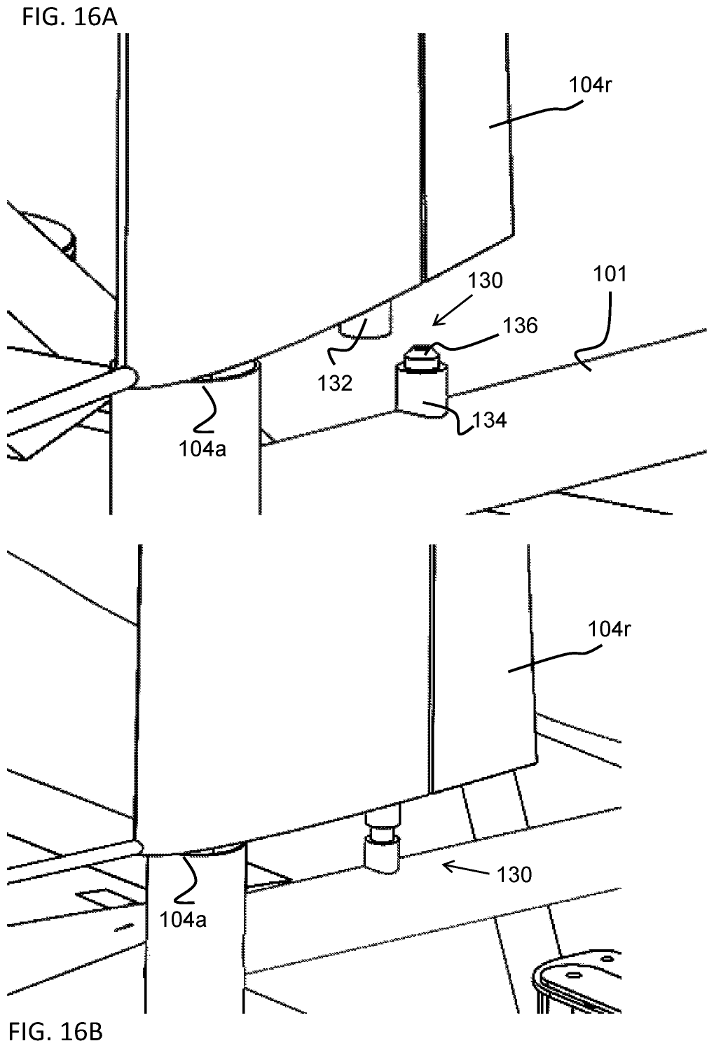

FIG. 16 shows a flying surface in the form of a rudder and/or stabilizer 104 that may be locked into position an optional transitioning device 105 as previously described, that optionally and preferably utilize an electromagnetic locking assembly 130. Magnetic and/or electromagnetic locking assembly 130, comprising a first housing 132, a second housing 134 and a locking member 136. Optionally and more preferably locking member 136 is controllable with actuator 105a of device 105 (not shown here). Assembly 130 may be associated with any flying surface and is not limited to use with a rudder and/or stabilizer 104, as is shown here.

First housing 132 is preferably configured to securely associated locking member 136 that is disposed with second housing 134. Optionally, first housing 132 may be associated with the aircraft body 101 or flying surface. Optionally second housing 134 may be associated with aircraft body or a flying surface.

Preferably locking member 136 comprises an electromagnet and/or magnet that is used to couple and/or interlock first housing 132 and second housing 134, such that they flying surface is locked into position. In embodiments, first housing 132 may comprise a first magnetic member and/or pole and second housing 134 featuring locking member 136 features a second magnetic member and/or pole corresponding to the first magnetic member and/or pole so as to interface with one another in a locking configuration. FIG. 16A shows the unlocked configuration while FIG. 16B shows the locked configuration.

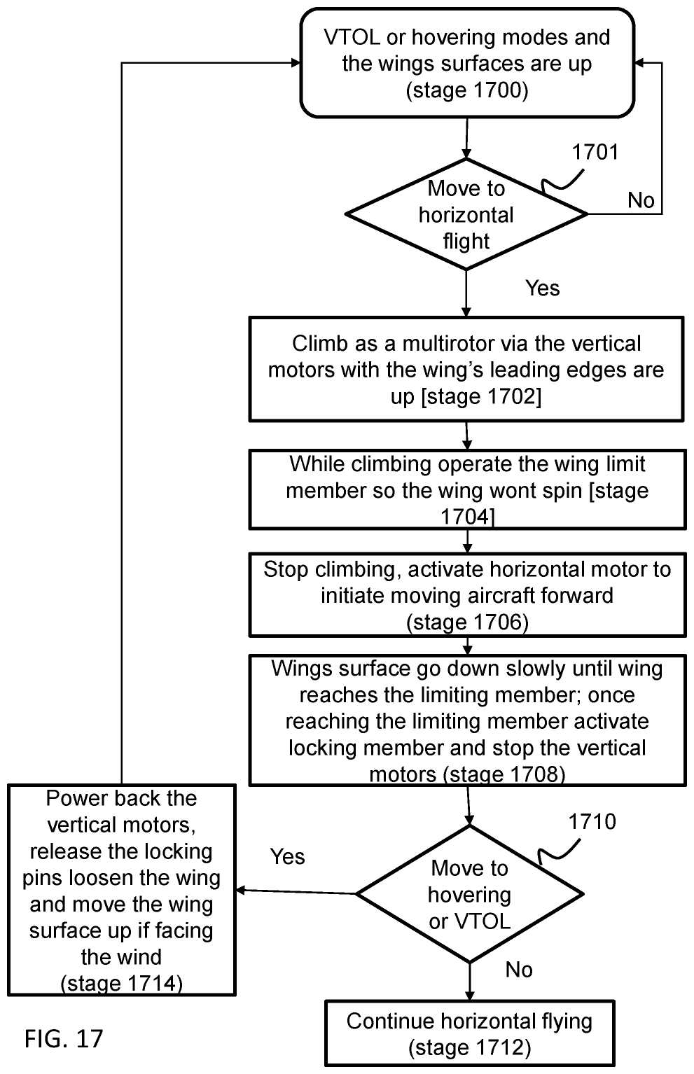

FIG. 17-19 shows flowcharts of optional methods according to the present invention for transitioning between vertical flight and horizontal flight, most preferably with transitioning device 105 previously described.

Now referring to FIG. 17 showing a flowchart depicting the method of control of an aircraft 100 featuring a flight transition device 105 that may optionally further feature one of: dual action assembly 125 and/or electromagnetic lock assembly 130.

FIG. 17 shows a flowchart depicting the necessary steps required to transition aircraft 100 from vertical takeoff flight (VTOL) to horizontal flight. In stage 1700, vertical takeoff is initiated by powering the vertical motors 106, wherein wings 102 are free to rotate along their axis, and wing surfaces 102f are preferably up. Next, in stage 1701 a decision to move to horizontal flight is established. Next, in stage 1702, continue climbing in the multirotor configuration wherein only the vertical motors are utilized and ensure that the leading edge 102L of wing 102 is up. Next, in stage 1704, while aircraft 100 continues to climb vertically actuate and/or activate device 105 so as to extract limiting member 125a, so as to causing wing 102 to stop spinning and/or rotating about its axis 102a once wing 102 contacts limiting member 125a. Next in stage 1706, aircraft 100 initiates a stop climbing maneuver by activating horizontal rotor(s) 108 so as to initiate horizontal flight. Next in stage 1708, locking member 125b is extracted and/or activates with actuator 105 to and vertical rotors 106 are de-activated and/or stopping vertical rotors 106 to fully transition to horizontal flight. In stage 1710 it is decided if to switch to vertical flight mode or to continue horizontal flight mode. If switching to vertical (VTOL) flight mode in stage 1714, the vertical rotors 106 are powered up and/or activated, and device 105 is activated so as to detract and/or retract second locking member 125b, to loosen wing 102, or flying surface, and maneuver aircraft 100 to so that the wings 102 faces the wind.

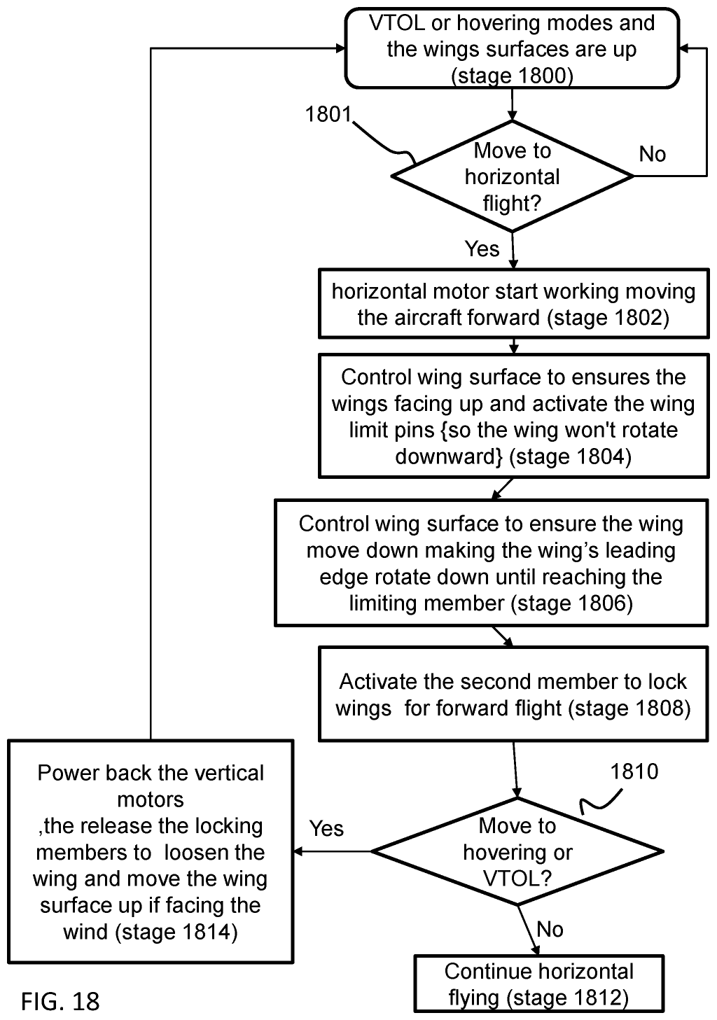

Now referring to FIG. 18 showing a flowchart depicting the method of control of an aircraft 100 featuring a flight transition device 105 optionally and preferably having a locking member 105e. As previously described locking member 105e may be selectively controlled with an actuator 105 to assume a first position wherein locking member 105e is partially extracted and therefore acting as a wing limiting pin position and a second position wherein member 105e is full extracted and therefore acting as a wing locking pin position to lock the wing 102 for a horizontal flight.

FIG. 18 shows a flowchart depicting the necessary steps required to transition aircraft 100 from vertical takeoff flight (VTOL) to horizontal flight. In stage 1800, vertical flight (VTOL) is active wherein vertical motors 106 are active and horizontal motor 108 is not activated, wherein wings 102 are free to rotate along their axis, and wing surfaces 102f are preferably up. Next, in stage 1801 a decision to move to horizontal flight is established. Next, in stage 1802, horizontal motor 108 is activated to initiate movement in the horizontal direction. Next, in stage 1804, activate transitioning device 105 so as to allow member/pin 105e to assume the first partially extracted position therein limiting the wing's 102 rotation and/or spin. Next in stage 1806, the wings surface 102f is moved down to ensure that the wing 102 and pin 105e are in full contact. Next in stage 1808, device 105 is actuated with actuator 105a so as to allow member/pin 105e to assume its locking position and/or second position allowing wing 102 to be locked in for horizontal flight. In stage 1810 it is decided if to switch to vertical flight mode or to continue horizontal flight mode. If switching to vertical (VTOL) flight mode in stage 1814, the vertical rotors 106 are powered up and/or activated, and device 105 is activated so as to detract and/or retract pin 105e to release wing 102 and maneuver aircraft 100 to so that the wings 102 faces the wind.

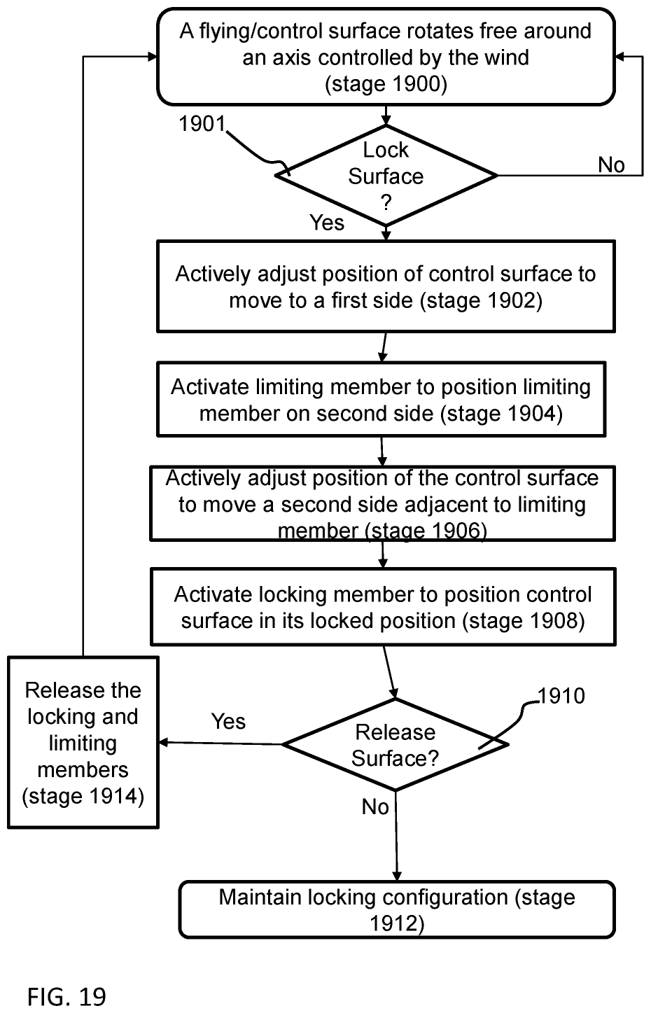

Now referring to FIG. 19 shows a flowchart depicting the method of control of an aircraft 100 featuring a flight transition device 105 that features a dual action assembly 125 and/or electromagnetic lock assembly 130, as shown in FIG. 13-16. The method shown in FIG. 19 depicts a method for locking a flying surface, for example a wing 102, stabilizer 104, rudder or the like, into a locked position.

In stage 1900, the flying surface 102, 104 is free to rotate along its axis. For example, as shown in FIG. 16A, stabilizer 104 is free to rotate about its axis.

Next, in stage 1901 a decision to move to lock the flying surface or not is established.

Next, in stage 1902, if locking decision has been established, at least one or more control surface of the flying surface to be locked is manipulated so as to urge the flying surface to a first side, for example as shown in FIG. 14A.

Next in stage 1904, device 105 actives a limiting member, for example first action limiting member 125a, as shown in FIG. 14A, or locking member 136 is extended to limit the rotation of flying surface, for example as shown in FIG. 16A. Accordingly, a limiting member is extended so as to limit the rotational movement of the flying surface.

Next in stage 1906, the flying surface's is manipulated with its respective control surface for example flaps 102f or wing 102, as shown in FIG. 14A, and/or a rudder 104r as of stabilizer 104 as shown in FIG. 16A, so as to stabilized and position the flying surface in preparation for locking it.

Next in stage 1908, locking of the flying surface is established, for example as shown in FIGS. 16B and 14B, by applying an optional locking member 136 or 125b. The flying surface is prevented from rotating about its axis, which is maintained until a decision to release the flying surface is established in stage 1910.

Next in stage 1914, if the flying surface is to be released the respective limiting and/or locking members are retracted to release the flying surface. For example, as shown in FIG. 16A-B, when unlocking stabilizer 104, electromagnetic lock assembly 130 is released by reversing the electromagnetic field between first housing and second housing, and by retracting locking member 136. For example, as shown in FIG. 14A-B, when unlocking wing 102, the dual action transition assembly 125 is controlled to retract both first action limiting member 125a and second action locking member 125b to unlock wing 102 allowing it to rotate freely about its axis 102a.

In some embodiments wherein assembly 125 comprises only a first limiting member 125a, the method described above would not include stages 1906 and 1908.

As used herein the term “about” refers to +/−10%.

The terms “comprises”, “comprising”, “includes”, “including”, “having” and their conjugates mean “including but not limited to”. The term “consisting of” means “including and limited to”. The term “consisting essentially of” means that the composition, method or structure may include additional ingredients, steps and/or parts, but only if the additional ingredients, steps and/or parts do not materially alter the basic and novel characteristics of the claimed composition, method or structure.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

In those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

While the invention has been described with respect to a limited number of embodiment, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not described to limit the invention to the exact construction and operation shown and described and accordingly, all suitable modifications and equivalents may be resorted to, falling within the scope of the invention.

It should be noted that where reference numerals appear in the claims, such numerals are included solely or the purpose of improving the intelligibility of the claims and are no way limiting on the scope of the claims.

Having described a specific preferred embodiment of the invention with reference to the accompanying drawings, it will be appreciated that the present invention is not limited to that precise embodiment and that various changes and modifications can be effected therein by one of ordinary skill in the art without departing from the scope or spirit of the invention defined by the appended claims.

Further modifications of the invention will also occur to persons skilled in the art and all such are deemed to fall within the spirit and scope of the invention as defined by the appended claims.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Citation or identification of any reference in this application shall not be construed as an admission that such reference is available as prior art to the invention.

Section headings are used herein to ease understanding of the specification and should not be construed as necessarily limiting.

While the invention has been described with respect to a limited number of embodiments, it will be appreciated that many variations, modifications and other applications of the invention may be made.

What is claimed is:

1) A device (105) for flight mode transitioning between vertical flight mode and horizontal flight mode in a vertical take-off and landing (VTOL) aircraft, the device comprising:
a) an actuator;
b) an adaptor associated with said actuator for translating the actuator motion to;
c) a locking member responsive to said linear motion provided with said adaptor so as to extend or retract said locking member along an axial direction.

2) The device of claim 1 further comprising a locking member housing.

3) The device of claim 1 wherein said adaptor is functionally coupled to a push-pull cable.

4) The device of claim 3 wherein said cable interfaces said adaptor and said locking member.

5) The device of claim 1 further comprising a support member (105s).

6) The device of claim 1 further comprising an electronics circuitry interface (105i).

7) The device of claim 1 wherein said locking member is provided in the form of a locking assembly (125) including a limiting member (125a).

8) The device of claim 7 wherein said locking assembly (125) further comprising a locking member (125b).

9) The device of claim 7 wherein said locking assembly (125) is configured to be controlled with at least one actuator.

10) The device of claim 7 wherein said locking assembly (125) is configured to be controlled with two actuators, a first actuator dedicated to control said limiting member (125a) and a second actuator dedicated to control said locking member (125b).

11) The device of claim 8 wherein said actuator is a linear actuator configured to linearly actuate said locking assembly (125).

12) The device of claim 8 wherein said actuator is a rotating actuator configured to rotatably actuate said locking assembly (125).

13) A Vertical Take-Off and Landing (VTOL) aircraft (100) comprising a body (101), at least two vertical rotors (106), electronic circuitry module (110), at least one wing (102), and at least one flight mode transitioning device (105) according to any one of claims 1-12, wherein said transitioning device is associated with a portion of said body; and wherein said at least one wing (102) is configured as an airfoil having a leading edge (102L), a trailing edge (102t); said trailing edge featuring at least one flap (102f) along a portion of the length of said wing (102), an axial channel (102a) disposed adjacent to said leading edge, said axial channel (102a) axially coupled to said body (101) providing said wing with free rotation about an axis formed along said axial channel.

14) The aircraft of claim 13 wherein said wing (102) further comprises a wing lock recess (102b) disposed adjacent to said trailing edge (102t) wherein said wing lock recess (102b) is configured to receive a locking member (105e) of said flight mode transitioning device (105).

15) The multi-rotor aircraft of claim 14 further comprising at least one horizontal rotor (108).

16) The multi-rotor aircraft of claim 14 further comprising at least one stabilizer (104).

17) A method for transitioning between vertical flight and horizontal flight of a multirotor aircraft featuring the device (105) according to claim 1 the method comprising:
a) flight computer identifying end of vertical flight (VTOL) and transition to horizontal flight; differentially activating said rotors so as to control airflow about said wings (102) so as position said wings (102);
b) wing control surface adjustment wherein wing flaps (102f) are positioned up;
c) initiating transitioning device (105) with a signal from said electronic circuitry module (110); wherein actuator (105a) is activated to partially activate locking member (105e);
d) wing control surface adjustment wherein wing flaps (102f) are positioned down to engage locking recess (102b) with locking member (105e);
e) activating said transition device (105) to fully engage said locking member (105e) within said wing lock recess (102b) to lock said wing (102) relative to said body (101);
f) engage in horizontal flight mode by controlled activation of said rotors;
g) maintain wing lock mode until transition form horizontal flight mode to vertical flight mode is required;
h) activating actuator (105a) to disengage locking member (105e) from wing lock recess (102b) to release said at least one wing (102).

18) The method of claim 9 wherein said locking member is partially activated and/or extracted prior to interfacing with said wing (102) about said wing lock recess (102b).

19) The device of claim 1 further comprising a support arm assembly (107), the support arm assembly comprising a support arm (107a), a rail assembly having a wing rail (107w) and a body rail (107b) each rail having corresponding tracks (107r), and wherein the support arm (107a) is controlled with an actuator (105a).

20) The device of claim 19, wherein said support arm (107a) is directly associated with a dedicated actuator (105a).

21) A method for transitioning between vertical flight mode to horizontal flight mode, the method comprising activating the device according to any one of claims 19 or 20, wherein the position of arm 107a along track 107r is proportional to the vertical flight parameters and/or progression.

22) The aircraft of claim 7 wherein said recess (102b) further comprises a gate (102c) configured to allow open or close access to said recess.

23) The aircraft of claim 22 wherein said gate (102c) is bidirectional.

24) An apparatus for a VTOL enabled aircraft (100) the apparatus comprising:
a) a flying surface (102,104) having a control surface (102f,104r) and a freely rotatable axis (102a, 104a); and
b) a flight transitioning device (105,125,130) having at least one actuator (105a) and a controllable locking member (105e,125b,136,107a); wherein the controllable locking member is configured to associate with a portion of said flying surface.

25) The apparatus of claim 24 wherein said flying surface further comprises a locking recess (102b, 132).

26) The apparatus of claim 24 wherein said flying surface further comprises an extension member (102e, 132).

27) The apparatus of claim 24 wherein said flight transitioning device (105,125) further comprises a limiting member (125a).

28) The apparatus of claim 24 wherein said controllable locking member (105e) is provided in the form of a controllable pin having at least two or more controllable linearly extendible positions including a limiting position and a locking position.

29) The apparatus of claim 24 wherein said actuator is functionally associated with flight transitioning device (105,125,107,130) with an actuator adaptor (105b) wherein said adaptor is configured to facilitate either linear or rotational movement.

30) The apparatus of claim 24 wherein said flying surface further comprises a rail assembly (107c) having a wing rail (107w) and a body rail (107b) each rail having corresponding tracks (107r).

31) The apparatus of claim 30 wherein said controllable locking member is configured in the form of a cross arm (107a) configured to be controlled with said actuator (105a), wherein said actuator controls the position of said cross arm along said rail assembly (107c).

32) The apparatus of claim 24 wherein said a controllable locking member is configured in the form of an electromagnetic locking member (136).

33) The apparatus of claim 24 wherein said flight transitioning device (105,125) features a rotatably actuated limiting member (125a) and a rotatably actuated locking member (125b).

34) The apparatus of claim 33 wherein said rotatable actuated limiting member (125a) and locking member (125b) are configured to interface with a flying surface extension member (102e, 132).

35) The apparatus of any one of claims 34 or 26 wherein said extension member (102e, 132) is linearly controllable and configured to extend from a surface of said flying surface.

36) The apparatus of claim 24 wherein said recess (102b) further comprises a gate (102c) configured to open or close access to said recess.

37) The apparatus of claim 36 wherein said gate (102c) is bidirectional.

38) A method for transitioning between vertical flight and horizontal flight of a multirotor aircraft featuring a flying surface (102,104) that is freely rotatable about its axis (102a,104a) and the apparatus of any one of the preceding claims, the method comprising:
a) flight computer determining/identifying an end of vertical flight (VTOL) and to initiate transitioning to horizontal flight;
b) the control surface (102f,104r) of said flying surface are controlled to position the flying surface to a first side;
c) said flight transitioning apparatus activates said actuator (105a) to activate a limiting member (105e, 125a, 136) on a second side that is opposite said first side; and
d) the control surface (102f,104r) of said flying surface (102,104) are controlled so as to position the flying surface to said second side allowing said flying surface to interface with said limiting member.

39) The method of claim 28 further comprising: activating said flight transitioning apparatus to activate said actuator (105a) to activate a locking member (105e, 125b, 136) so as to lock the flying surface into its position.

40) The method of any one of claims 38 or 39 further comprising initiating horizontal flight by activating at least one horizontal rotor.

41) The method of claim 40 wherein horizonal flight is initiated by activating at least one horizontal rotor after activating said limiting member (125a) but prior to activating said locking member (125b).

42) The method of claim 40 wherein horizonal flight is initiated by activating at least one horizontal rotor after activating said locking member.

43) The method of claim 40 further comprising deactivating at least one or more vertical rotors.

44) The method of any one of claims 38 or 39 wherein at least one or more vertical rotors are deactivated after activating said limiting member (125a) and prior to activating said locking member (125b).

45) The method of claim 39 wherein at least one or more vertical rotors are deactivated after activating said locking member.
